(19) United States
(12) Patent Application Publication
(10) Pub. No.: US 2024/0310761 A1
(43) Pub. Date: Sep. 19, 2024

(54) FIXING DEVICE AND IMAGE FORMING APPARATUS

(71) Applicant: Toshiba Tec Kabushiki Kaisha, Tokyo (JP)

(72) Inventor: Takeshi KOJIMA, Tagata Shizuoka (JP)

(73) Assignee: Toshiba Tec Kabushiki Kaisha, Tokyo (JP)

(21) Appl. No.: 18/123,121

(22) Filed: Mar. 17, 2023

(51) Int. Cl. G03G 15/20; G03G 15/00

(52) U.S. Cl. CPC G03G 15/205; G03G 15/2053; G03G 15/2064; G03G 15/5004; G03G 2215/2035

(57) ABSTRACT

A fixing device includes a fixer, a temperature sensor, and a controller. The fixer includes a fixed body and a heat source, the fixed body is configured to rotate and is in contact with a medium, wherein the medium is configured to receive a developer image, and the heat source is configured to supply heat to the fixed body. The temperature sensor is configured to measure a temperature of a surface of the fixed body that is in contact with the medium. The controller is configured to clean the fixer when an estimated value of the temperature of the fixed body is higher than a predetermined value.

### FIELD

Embodiments described herein relate generally to a fixing device and an image forming apparatus.

### BACKGROUND

An image forming apparatus that is provided in a workplace or the like includes a fixing unit that applies heat and pressure to a printing medium to fix a toner image to the printing medium. The fixing unit includes a temperature sensor that detects a temperature of a surface of a fixing rotating body (e.g. a fixed member, fixed body, etc.). The fixing unit (e.g., fixer, etc.) controls the surface temperature of the fixing rotating body (e.g., fixed member, fixed body, etc.) to a target value based on a detection signal of the temperature sensor.

However, there may be a case where the temperature sensor cannot accurately detect the temperature due to contamination or the like. When the temperature sensor cannot detect the accurate temperature, there is a problem in that the controller controls the surface temperature of the fixing rotating body to a temperature different from a target value.

### DESCRIPTION OF THE DRAWINGS

FIG. 1 is a diagram illustrating a configuration of an image forming apparatus including a fixing device according to at least one embodiment;

FIG. 2 is a diagram illustrating a first configuration of a fixing unit in the fixing device according to at least one embodiment;

FIG. 3 is a block diagram illustrating a configuration of a control system in the image forming apparatus including the fixing device;

FIG. 4 is a diagram illustrating a configuration of a heater control circuit in the fixing device;

FIG. 5 is a diagram illustrating a relationship between an input voltage to a center heater and a center WAE estimated value in a ready state of the fixing device;

FIG. 6 is a diagram illustrating a relationship between an input voltage to a side heater and a side WAE estimated value in a ready state of the fixing device;

FIG. 7 is a diagram illustrating a relationship between a difference between the center WAE estimated value and the side WAE estimated value in the fixing device and an increase in actual temperature in a heating roller;

FIG. 8 is a diagram illustrating a table where determination results of the increase in actual temperature with respect to the difference between the WAE estimated values illustrated in FIG. 7 are collected;

FIG. 9 is a flowchart illustrating an operation of a fixing unit cleaning process in the image forming apparatus including the fixing device;

FIG. 10 is a flowchart illustrating an operation of a fixing unit cleaning process in the image forming apparatus including the fixing device;

FIG. 11 is a diagram illustrating a second configuration of the fixing unit used in the fixing device;

FIG. 12 is a diagram illustrating a configuration of the heater unit in the fixing unit according to the second configuration used in the fixing device;

FIG. 13 is a diagram illustrating a third configuration of the fixing unit used in the fixing device;

FIG. 14 is a diagram illustrating a configuration of the heater unit in the fixing unit according to the third configuration used in the fixing device;

FIG. 15 is a diagram illustrating a fourth configuration of the fixing unit used in the fixing device;

FIG. 16 is a diagram illustrating a configuration of the heater unit in the fixing unit according to the fourth configuration used in the fixing device;

FIG. 17 is a diagram illustrating a fifth configuration of the fixing unit used in the fixing device; and

FIG. 18 is a diagram illustrating a configuration of the heater unit in the fixing unit according to the fifth configuration used in the fixing device.

### DETAILED DESCRIPTION

In general, according to one embodiment, a fixing device includes a fixing unit, a temperature sensor, and a controller. The fixing unit (e.g., fixer) includes a fixing member (e.g., fixed member) and a heat source, the fixing member being in contact with a medium to which a developer image is transferred, and a heat source configured to supply heat to the fixing member. The temperature sensor is configured to measure a temperature of a surface of the fixing member in contact with the medium. The controller is configured to clean the fixing unit (e.g., fixer) when an estimated value of the temperature of the fixing member (e.g., fixed body) is higher than a predetermined reference value.

Hereinafter, an image forming apparatus according to the embodiment will be described with reference to the drawings.

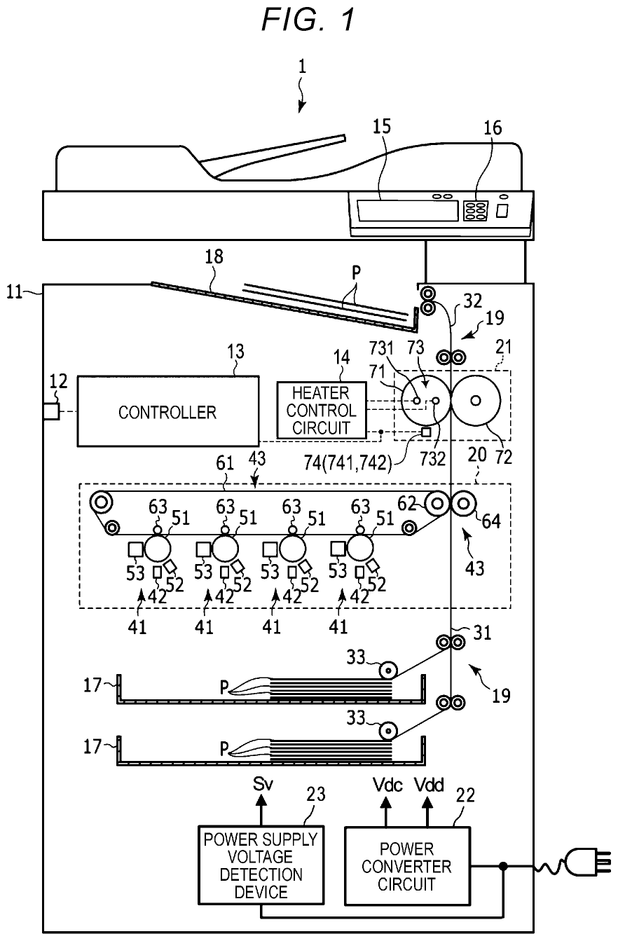

FIG. 1 is a diagram illustrating a configuration example of an image forming apparatus 1 including a fixing device according to the embodiment.

The image forming apparatus 1 is, for example, a digital multi-functional peripheral (MFP) that executes various processes such as an image forming process while conveying a recording medium such as a printing medium. The image forming apparatus 1 transfers a toner image formed using an electrophotographic method to a printing medium as a recording medium and fixes the toner image on the printing medium using a fixing unit (e.g., a fixer, etc.).

The image forming apparatus 1 receives toner from a toner cartridge and forms an image on the printing medium using the received toner. The toner may be a monochrome toner or may be a toner of a color such as cyan, magenta, yellow, or black. The toner may be decolorable toner that is decolored when heat is applied to the toner.

As illustrated in FIG. 1, the image forming apparatus 1 includes a housing 11, a communication interface 12, a controller (e.g., a system controller) 13, a heater control circuit 14, a display device 15, an operation device 16, a plurality of paper trays 17, a paper discharge tray 18, a conveyance mechanism 19, an image forming mechanism 20, a fixing unit (e.g., a fixer) 21, a power converter circuit 22, and a power supply voltage detection device 23.

The housing 11 is a main body of the image forming apparatus 1. The housing 11 accommodates the communication interface 12, the controller 13, the heater control circuit 14, the display device 15, the operation device 16, the plurality of paper trays 17, the paper discharge tray 18, the conveyance mechanism 19, the image forming mechanism 20, the fixing unit (e.g., fixer) 21, the power converter circuit 22, and the power supply voltage detection device 23.

The communication interface 12 is an interface for communication with another apparatus to which the image forming apparatus is connected via the network. The communication interface 12 is used for communication with an external apparatus. The external apparatus is a user terminal that instructs a print job or a server as an external management apparatus. The communication interface 12 is configured with, for example, a LAN connector. The communication interface 12 may execute wireless communication with another apparatus according to a standard such as Bluetooth (registered tradename) or Wi-fi (registered tradename).

The controller (system controller) 13 executes controls, data processing, and the like on the respective units of the image forming apparatus 1. For example, the controller 13 is a computer including a processor, a memory, and various interfaces. The controller 13 executes controls, data processing, and the like on the respective units of the image forming apparatus 1 by the processor executing programs stored in the memory. The controller 13 is connected to the respective units (e.g., the communication interface, the conveyance mechanism, the image forming mechanism, the fixer, the power converter circuit, the power supply voltage, etc.) in the housing 11 via various internal interfaces.

The controller 13 generates a print job based on image data or the like received from an external apparatus via the communication interface 12. The image data in the print job is data representing an image to be formed on a printing medium P. The image data may be data for forming on a single printing medium P or may be data for forming an image on a plurality of printing media P. The print job may include information representing printing conditions such as information representing whether the printing is color printing or monochrome printing.

The controller 13 is an engine controller that controls operations of the conveyance mechanism 19, the image forming mechanism 20, and the fixing unit (e.g., fixer) 21. For example, the controller 13 controls the conveyance mechanism 19 to convey the printing medium P. The controller 13 controls the image forming mechanism 20 to form a developer image and controls the developer image to be transferred to the printing medium P. The controller 13 controls the fixing unit (e.g., fixer) 21 to fix the developer image to the printing medium P. The controller 13 controls the operation of the conveyance mechanism 19, the image forming mechanism 20, and the fixing unit (e.g., fixer) 21 such that the image of the image data in the print job is formed on the printing medium P.

The image forming apparatus 1 may be configured to include an engine controller separately from the controller 13. For example, in the image forming apparatus 1, an engine controller that controls at least one of the conveyance mechanism 19, the image forming mechanism 20, the fixing unit (e.g., fixer) 21, and the like may be provided separately from the controller 13. The engine controller provided separately from the controller 13 may acquire information required for the control from the controller 13.

The heater control circuit 14 is a temperature control device that controls energization to a heater 73 (e.g., a center heater 731 and a side heater 732) in the fixing unit 21 described below based on the control of the controller 13. The heater control circuit 14 generates energization powers PC1 and PC2 for energizing the heater 73 of the fixing unit 21. The heater control circuit 14 supplies the energization power PC1 to the center heater 731 and supplies the energization power PC2 to the side heater 732. The detailed description of the heater control circuit 14 will be described below.

The display device 15 includes a display that displays an image corresponding to an image signal input from a display control unit such as the controller 13 or a graphic controller. For example, the display device 15 causes the display to display a setting screen for various settings of the image forming apparatus 1.

The operation device 16 supplies an operation signal corresponding to an operation of the operation device to the controller 13. The operation device is, for example, a touch sensor, a numeric keypad, a power key, various function keys, or a keyboard. The touch sensor acquires information representing a position designated in a region. The touch sensor may be configured as a touch panel integrated with the display device 15. The display device 15 and the operation device 16 may be provided in an operation panel as a user interface.

The power converter circuit 22 supplies a direct current voltage to each of the units in the image forming apparatus 1 using an alternating current voltage from an alternating current power supply AC such as an external power supply. For example, the power converter circuit 22 generates direct current voltages Vdd and Vdc from the alternating current voltage of the alternating current power supply AC. The power converter circuit 22 supplies the direct current voltage Vdd to the controller 13 and supplies the direct current power supply voltage Vdc to the heater control circuit 14. The power converter circuit 22 supplies a direct current voltage required for image formation that is generated from the alternating current voltage of the alternating current power supply AC to the image forming mechanism 20. The power converter circuit 22 supplies a direct current voltage required for the conveyance of the printing medium P that is generated from the alternating current voltage of the alternating current power supply AC to the conveyance mechanism 19.

The power supply voltage detection device 23 detects a voltage value of the alternating current voltage of the alternating current power supply AC that is supplied from an external power supply, and outputs a power supply voltage detection result Sv. The configuration of the power supply voltage detection device 23 is not particularly limited. The power supply voltage value may be any value as long as the voltage can be detected. The power supply voltage detection device 23 may detect a voltage value of the direct current power supply voltage Vdc converted by the power converter circuit 22 instead of the voltage value of the alternating current voltage of the alternating current power supply AC that is supplied from a power supply source. The power supply voltage detection result Sv output from the power supply voltage detection device 23 is input to the controller 13.

The controller 13 stores the power supply voltage value represented by the power supply voltage detection result Sv. The controller 13 may cause the communication interface 12 to transmit the power supply voltage value represented by the power supply voltage detection result Sv to a host computer via the network. Here, the controller 13 may store transmission destination information such as a network address of the host computer in a nonvolatile memory or the like. The controller 13 may cause the communication interface 12 to transmit the power supply voltage value represented by the power supply voltage detection result Sv to another image forming apparatus connected via the network. The controller 13 may transmit the power supply voltage value represented by the power supply voltage detection result Sv to another image forming apparatus connected to the image forming apparatus 1 via an interface.

Next, a configuration of a conveyance system in the image forming apparatus 1 will be described.

The plurality of paper trays 17 are cassettes accommodating the printing media P, respectively. The paper tray 17 is configured to supply the printing medium P from the outside of the housing 11. For example, the paper tray 17 is configured to be drawn out from the housing 11.

The paper discharge tray 18 is a tray that supports the printing medium P discharged from the image forming apparatus 1.

The conveyance mechanism 19 is a mechanism that conveys the printing medium P in the image forming apparatus 1. As illustrated in FIG. 1, the conveyance mechanism 19 includes a plurality of conveyance paths. For example, the conveyance mechanism 19 includes a paper feed conveyance path 31 and a paper discharge conveyance path 32.

The paper feed conveyance path 31 and the paper discharge conveyance path 32 are configured with a plurality of motors, a plurality of rollers, and a plurality of guides. The plurality of motors rotate shafts based on a control of the controller 13 to rotate the rollers that operate together with the rotation of the shafts. The plurality of rollers rotate to move the printing medium P. The plurality of guides control a conveying direction of the printing medium P.

The paper feed conveyance path 31 picks up the printing medium P from the paper tray 17 and supplies the picked printing medium P to the image forming mechanism 20. The paper feed conveyance path 31 includes a plurality of pickup rollers 33, each of the plurality of pickup rollers 33 corresponding to each of the paper trays. Each of the pickup rollers 33 picks up the printing medium P of the paper tray 17 to the paper feed conveyance path 31.

The paper discharge conveyance path 32 is a conveyance path through which the printing medium P on which an image is formed is discharged to the outside of the housing 11. The printing medium P discharged through the paper discharge conveyance path 32 is supported by the paper discharge tray 18.

Next, a configuration of the image forming mechanism 20 in the image forming apparatus 1 will be described.

The image forming mechanism 20 forms an image on the printing medium P. The image forming mechanism 20 forms the image on the printing medium P based on the print job generated by the controller 13.

The image forming mechanism 20 includes a plurality of process units (e.g., image forming stations) 41, a plurality of exposure units (e.g., a plurality of exposure devices or exposers) 42, and a transfer mechanism 43. The image forming mechanism 20 includes the exposure units (e.g., exposure devices) 42 for each of the process units (e.g., image forming stations) 41. The plurality of process units (e.g., e.g., image forming stations) 41 and the plurality of exposure units (e.g., exposure devices) 42 may have the same configuration, respectively. Therefore, one process unit (e.g., image forming stations) 41 and one exposure unit (e.g., exposure device) 42 will be described.

First, the process unit (e.g., image forming stations) 41 will be described.

The process unit (e.g., image forming stations) 41 forms a toner image. For example, the plurality of process units (e.g., image forming stations) 41 are provided corresponding to the kinds of toners. For example, the plurality of process units e.g., image forming stations) 41 correspond to color toners of cyan, magenta, yellow, black, and the like, respectively. Specifically, the toner cartridges containing toners of different colors are connected to the process units 41, respectively.

The toner cartridge includes a toner container and a toner feed mechanism. The toner container is a container containing toner. The toner feed mechanism is a mechanism that is configured with a screw or the like feeding toner into the toner container.

The process unit (e.g., image forming stations) 41 includes a photoconductive drum 51, a charging unit 52, and a developing unit 53.

The photoconductive drum 51 is a photoconductor including: a cylindrical drum; and a photosensitive layer that is formed on an outer circumferential surface of the drum. The photoconductive drum 51 rotates with a driving mechanism (not illustrated) at a constant speed.

The charging unit (e.g., charger) 52 uniformly charges a surface of the photoconductive drum 51. For example, the charging unit (e.g., charger) 52 applies a voltage (e.g., developing bias voltage) to the photoconductive drum 51 using a charging roller such that the photoconductive drum 51 is uniformly charged to a potential (e.g., contrast potential) having a negative polarity. The charging roller rotates due to the rotation of the photoconductive drum 51 while a predetermined pressure is applied to the photoconductive drum 51.

The developing unit (e.g., developer) 53 attaches the toner to the photoconductive drum 51. The developing unit (e.g., developer) 53 includes a developer container, an agitating mechanism, a developing roller, a doctor blade, an automatic toner control (ATC) sensor and the like.

The developer container receives and contains the toner supplied from the toner cartridge. The developer container contains a carrier in advance. The toner supplied from the toner cartridge is agitated by the agitating mechanism together with the carrier to form a developer in which the toner and the carrier are mixed. The carrier is contained in the developer container during manufacturing of the developing unit 53.

The developing roller rotates in the developer container such that the developer is attached to the surface. The doctor blade is a member disposed at a predetermined distance from the surface of the developing roller. The doctor blade removes a part of the developer attached to the surface of the rotating developing roller. As a result, a layer of the developer having a thickness corresponding to the distance between the doctor blade and the surface of the developing roller is formed on the surface of the developing roller.

The ATC sensor is, for example, a magnetic flux sensor that includes a coil and detects a voltage value generated in the coil. The detected voltage of the ATC sensor changes depending on the density of a magnetic flux from the toner in the developer container. That is, the controller 13 determines a density ratio (e.g., toner density ratio) of the toner to the carrier remaining in the developer container based on the detected voltage of the ATC sensor. The controller 13 operates a motor that drives a feeding mechanism of the toner cartridge based on the toner density ratio to feed the toner from the toner cartridge to the developer container of the developing unit 53.

Next, a configuration of the exposure unit (e.g., exposure device) 42 will be described.

The exposure unit (e.g., exposure device) 42 includes a plurality of light emitting elements. The exposure unit (e.g., exposure device) 42 forms a latent image on the photoconductive drum 51 by irradiating the charged photoconductive drum 51 with light from the light emitting elements. The light emitting element is, for example, a light emitting diode (LED). One light emitting element is configured to irradiate one point on the photoconductive drum 51 with light. The plurality of light emitting elements are arranged in a main scanning direction that is a direction parallel to a rotation axis of the photoconductive drum 51.

The exposure unit 42 forms a latent image corresponding to one line on the photoconductive drum 51 by irradiating the photoconductive drum 51 with light from the plurality of light emitting elements arranged in the main scanning direction. The exposure unit 42 forms a latent image corresponding to a plurality of lines by continuously irradiating the rotating photoconductive drum 51 with light.

In the above-described configuration, when the surface of the photoconductive drum 51 charged by the charging unit (e.g., charger) 52 is irradiated with light from the exposure unit 42, an electrostatic latent image is formed. When the layer of the developer formed on the surface of the developing roller approaches the surface of the photoconductive drum 51, the toner in the developer is attached to the latent image formed on the surface of the photoconductive drum 51. As a result, a toner image is formed on the surface of the photoconductive drum 51.

Next, a configuration of the transfer mechanism 43 will be described.

The transfer mechanism 43 is configured to transfer the toner image formed on the surface of the photoconductive drum 51 to the printing medium P. The transfer mechanism 43 transfers the toner image formed on the surface of the photoconductive drum 51 to a primary transfer belt 61, and transfers the toner image transferred to the primary transfer belt 61 to the printing medium P.

The transfer mechanism 43 includes, for example, the primary transfer belt 61, a secondary transfer facing roller 62, a plurality of primary transfer rollers 63, and a secondary transfer roller 64.

In the configuration example illustrated in FIG. 1, the primary transfer belt 61 is an endless belt that is wound around the secondary transfer facing roller 62 and a plurality of winding rollers. In the primary transfer belt 61, an inner surface (inner circumferential surface) is in contact with the secondary transfer facing roller 62 and the plurality of winding rollers, and an outer surface (outer circumferential surface) faces the photoconductive drum 51 of the process unit 41.

The secondary transfer facing roller 62 rotates with a motor. The secondary transfer facing roller 62 rotates to convey the primary transfer belt 61 in a predetermined conveying direction. The plurality of winding rollers are configured to be freely rotatable. The plurality of winding rollers rotates according to the movement of the primary transfer belt 61 by the secondary transfer facing roller 62.

The plurality of primary transfer rollers 63 are configured to bring the primary transfer belt 61 into contact with the photoconductive drum 51 of the process units 41, respectively. The plurality of primary transfer rollers 63 are provided corresponding to the photoconductive drums 51 of the plurality of process units 41. Specifically, the plurality of primary transfer rollers 63 are provided at positions (e.g., primary transfer positions) where the primary transfer rollers 63 and the photoconductive drums 51 of the process units (e.g., image forming stations) 41 corresponding thereto face each other with the primary transfer belt 61 interposed therebetween. The primary transfer rollers 63 come into contact with the inner circumferential surface side of the primary transfer belt 61, and displace the primary transfer belt 61 to the photoconductive drum 51 side. As a result, the primary transfer rollers 63 bring the outer circumferential surface of the primary transfer belt 61 into contact with the photoconductive drum 51.

The secondary transfer roller 64 is provided at a position (secondary transfer position) where the secondary transfer roller 64 faces the primary transfer belt 61. The secondary transfer roller 64 comes into contact with the outer circumferential surface of the primary transfer belt 61 and applies pressure. As a result, a transfer nip where the secondary transfer roller 64 and the outer circumferential surface of the primary transfer belt 61 are in close contact with each other is formed. When the printing medium P passes through the transfer nip, the secondary transfer roller 64 presses the printing medium P that is passing through the transfer nip against the outer circumferential surface of the primary transfer belt 61.

The secondary transfer roller 64 and the secondary transfer facing roller 62 rotate such that the printing medium P supplied through the paper feed conveyance path 31 is conveyed while the printing medium P is interposed between the secondary transfer roller 94 and the secondary transfer facing roller 92. As a result, the printing medium P passes through the transfer nip.

In the above-described configuration, when the outer circumferential surface of the primary transfer belt 61 comes into contact with the photoconductive drum 51, the toner image formed on the surface of the photoconductive drum 51 is transferred to the outer circumferential surface of the primary transfer belt 61. When the image forming mechanism 20 includes the plurality of process units 41, the primary transfer belt 61 receives the toner images from the photoconductive drums 51 of the plurality of process units 41. The toner images transferred to the outer circumferential surface of the primary transfer belt 61 are conveyed by the primary transfer belt 61 up to the transfer nip where the secondary transfer roller 64 and the outer circumferential surface of the primary transfer belt 61 are in close contact with each other. When the printing medium P is present in the transfer nip, the toner images transferred to the outer circumferential surface of the primary transfer belt 61 are transferred to the printing medium P in the transfer nip.

Next, a configuration of the fixing unit (e.g., fixer) 21 in the image forming apparatus 1 will be described.

The fixing unit (e.g., fixer) 21 fixes the toner images to the printing medium P to which the toner images are transferred. The fixing unit (e.g., fixer) 21 operates based on a control of the controller 13. The fixing device according to the embodiment includes the fixing unit (e.g., fixer) 21, the heater control circuit 14, and the controller 13. The fixing unit (e.g., fixer) 21 includes a fixing rotating body (e.g., fixed body) as a fixing member, a pressurizing member, a heating member (e.g., heat source), and a temperature sensor. The fixing unit (e.g., fixer) 21 that is applied to the fixing device according to the embodiment can adopt various configurations. Here, FIG. 1 illustrates a first configuration example of the fixing unit 21.

In the first configuration example illustrated in FIG. 1, the fixing unit (e.g., fixer) 21 includes a heating roller 71, a press roller 72, the heater 73, and a temperature sensor 74. The heating roller 71 is an example of the fixing rotating body (e.g., fixing member, fixed member, fixed body). The press roller 72 is an example of the pressurizing member. The heater 73 is an example of the heating member (e.g., a heat source). The fixing unit 21 according to the first configuration example includes the heater 73 including a plurality of heat sources. In the first configuration example, the heater 73 includes the heater (e.g., a center heater) 731 that is an example of a first heat source and the heater (e.g., a side heater) 732 that is an example of a second heat source.

The temperature sensor 74 is an example of the temperature sensor that detects the temperature of a surface of the heating roller 71. In the embodiment, the fixing unit 21 includes a plurality of temperature sensors as the temperature sensor 74. Each of the temperature sensors 74 includes a contact portion in contact with the surface of the heating roller 71 and detects the temperature of a portion in contact with the contact portion. In the first configuration example, the temperature sensor 74 includes a temperature sensor (e.g., a center temperature sensor) 741 and a temperature sensor (e.g., a side temperature sensor) 742. The center temperature sensor 741 includes a contact portion in contact with a center region on the surface of the heating roller 71. The side temperature sensor 742 includes a contact portion in contact with a side region on the surface of the heating roller 71.

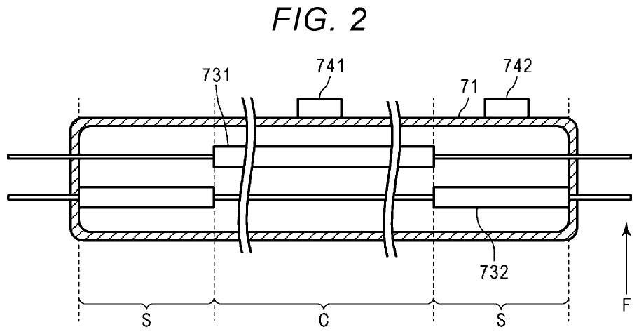

FIG. 2 is a cross-sectional view illustrating a configuration example around the heating roller 71 in the fixing unit 21 according to the first configuration example illustrated in FIG. 1.

The heating roller 71 is a fixing rotating body that rotates while being heated by the heater 73. The heating roller 71 includes a hollow core that is formed of metal and an elastic layer that is formed on an outer circumference of the core.

According to at least one embodiment, the diameter of the heating roller 71 is about ϕ30 mm. According to at least one embodiment, the core is formed of aluminum having a thickness of about 0.6 mm. According to at least one embodiment, the circumferential speed of the heating roller 71 is about 210 mm/s. The elastic layer is formed of, for example, fluororesin (e.g., tetrafluoroethylene resin). The diameter of the heating roller 71, the thickness of the core, the value of the circumferential speed, and raw material names of the core and the elastic layer are exemplary and are not limited thereto.

In the heating roller 71, the inside of the core is heated by the heater 73 that is a heating member (e.g., heat source) disposed inside the core formed in a hollow shape. The heat applied to the inside of the core is transmitted to the surface of the heating roller 71 (e.g., the surface of the elastic layer) disposed outside of the core. The fixing rotating body may be configured as an endless belt.

The press roller 72 is provided at a position facing the heating roller 71. The press roller 72 includes a core that has a predetermined outer diameter and is formed of metal and an elastic layer that is formed on an outer circumference of the core. The diameter of the press roller 72 is, for example, about ϕ30 mm. The elastic layer is formed of, for example, silicone rubber or fluorine rubber.

The press roller 72 applies pressure to the heating roller 71 using stress applied from a tension member. The pressure is, for example, about 150 N. In the press roller 72, the values of the diameter and the pressure and the raw material name are exemplary and are not particularly limited thereto. By the press roller 72 applying pressure to the heating roller 71, a nip (e.g., fixing nip) where the press roller 72 and the heating roller 71 are in close contact with each other is formed. The press roller 72 rotates with a motor (not illustrated). The press roller 72 rotates such that the printing medium P entering the fixing nip is moved and the printing medium P is pressed against the heating roller 71. Each of the heating roller 71 and the press roller 72 includes a release layer on the surface.

The heater 73 is configured with heating elements as a plurality of heat sources that generate heat with power supplied from the heater control circuit 14. The heater 73 in the fixing unit 21 according to the first configuration example illustrated in FIGS. 1 and 2 includes the center heater 731 and the side heater 732 as two heat sources (e.g., heating elements). Each of the center heater 731 and the side heater 732 is, for example, a halogen lamp heater including a halogen lamp.

The heater 73 in the fixing unit 21 according to the first configuration example is configured with two heaters including the center heater 731 and the side heater 732. The center heater 731 heats a center portion (e.g., center region C) of the heating roller 71 in a rotation axis direction. The side heater 732 heats a peripheral portion (e.g., side region S) of the heating roller 71 in the rotation axis direction other than the center portion. The printing medium P is conveyed in a conveying direction F illustrated in FIG. 2. For example, the center region C and the side region S may be set depending on the size of a medium used as the printing medium P.

Each of the center heater 731 and the side heater 732 generates heat with power supplied under the control of the controller 13. The power consumption of the center heater 731 and the side heater 732 is, for example, 600 W.

When the controller 13 executes a fixing process on the printing medium P having a narrow width in the rotation axis direction of the heating roller 71 (e.g., the conveying direction F of the printing medium P), the center region C of the heating roller 71 is heated. To heat the center region C of the heating roller 71, the controller 13 causes the heater control circuit 14 to operate the center heater 731 without operating the side heater 732.

When the controller 13 executes a fixing process on the printing medium P having a wide width in the rotation axis direction of the heating roller 71 (e.g., the conveying direction F of the printing medium P), the entire region (e.g., both of the center region C and the side region S) of the heating roller 71 are heated. To heat the entire region of the heating roller 71, the controller 13 causes the heater control circuit 14 to operate both of the center heater 731 and the side heater 732.

Each of the temperature sensor 741 and the temperature sensor 742 includes a contact portion in contact with the surface of the heating roller 71 and detects the temperature of a portion in contact with the contact portion. The temperature sensor 741 and the temperature sensor 742 are, for example, thermistors. The temperature sensor 741 and the temperature sensor 742 are arranged parallel to the rotation axis of the heating roller 71. In the first configuration example illustrated in FIG. 2, the temperature sensor 741 detects the temperature of the center region C of the heating roller 71 in the rotation axis direction (e.g., the center portion when the heating roller 71 is divided into three regions in the rotation axis direction). The temperature sensor 742 detects the temperature of the side region S of the heating roller 71 in the rotation axis direction (e.g., any one of side portions when the heating roller 71 is divided into three regions in the rotation axis direction).

Each of the temperature sensors 741 and 742 includes a contact portion (e.g., detection unit) in contact with the surface of the heating roller 71. In the temperature sensor 741, the contact portion comes into contact with the surface of the center region C of the heating roller 71 to detect the center region C of the heating roller 71. In the temperature sensor 742, the contact portion comes into contact with the surface of the side region S of the heating roller 71 to detect the temperature of the side region S of the heating roller 71.

Each of the temperature sensors 741 and 742 supplies a temperature detection result signal representing a temperature detection result to the controller 13. To heat the center region C of the heating roller 71, the controller 13 operates the center heater 731 based on the temperature detected by the temperature sensor 741. To heat the entire region of the heating roller 71, the controller 13 operates the center heater 731 and the side heater 732 based on the temperatures detected by the temperature sensors 741 and 742.

The heating roller 71 and the press roller 72 apply heat and pressure within a controlled predetermined temperature range to the printing medium P exceeding the fixing nip. The toner of the printing medium P is fixed to the surface of the printing medium P with the heat from the heating roller 71 and the pressure from the heating roller 71 and the press roller 72. As a result, the toner image is fixed to the printing medium P that passes the fixing nip. The printing medium P that passes the fixing nip is introduced into the paper discharge conveyance path 32 and is discharged out from the housing 11.

Next, a configuration of a control system in the image forming apparatus 1 according to the embodiment will be described.

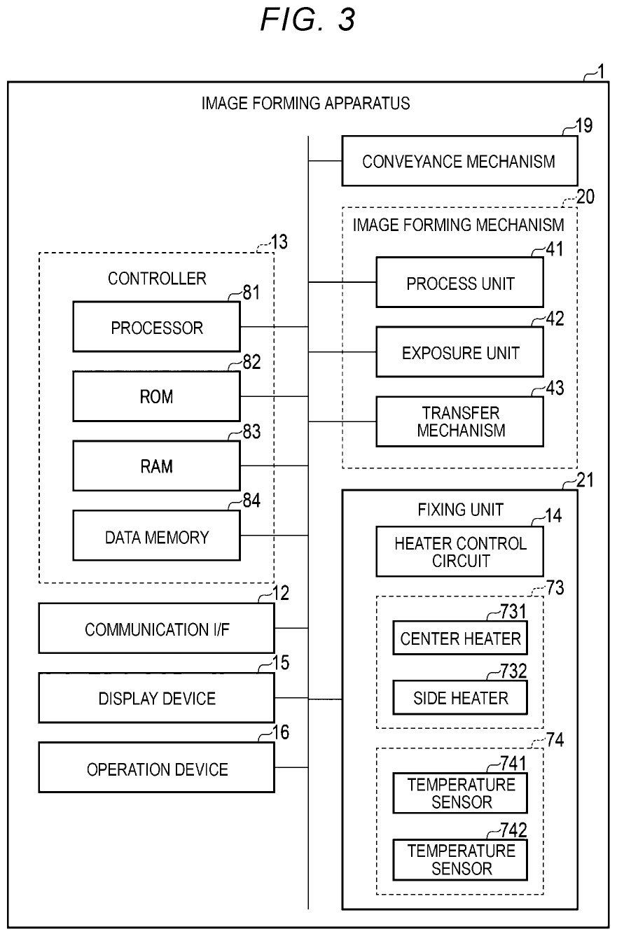

FIG. 3 is a block diagram illustrating the configuration example of the control system in the image forming apparatus 1.

As illustrated in FIG. 3, in the image forming apparatus 1, the communication interface 12, the heater control circuit 14, the display device 15, the operation device 16, the conveyance mechanism 19, the image forming mechanism 20, the fixing unit (e.g., fixer, fixing device) 21, and the like are connected to the controller (e.g., system controller) 13.

The controller 13 includes a processor 81, a read only memory (ROM) 82, a random-access memory (RAM) 83, and a data memory 84. The controller 13 configures a computer together with the processor 81, the ROM 82, the RAM 83, and the data memory 84. The controller 13 may include an ASIC or the like that is a processor for image processing.

The processor 81 corresponds to a central part of the computer, such as the controller 13. The processor 81 controls the respective units of the image forming apparatus 1 according to an operating system or an application program. The processor 81 is, for example, a central processing unit (CPU).

The ROM 82 and the RAM 83 correspond to a main memory of the computer, such as the controller 13. The ROM 82 is a nonvolatile memory area, and the RAM 83 is a volatile memory area. The ROM 82 stores an operating system or an application program. The ROM 82 stores control data required to execute a process for allowing the processor 81 to control the respective units. The RAM 83 is used as a work area where data is appropriately rewritten by the processor 81. The RAM 83 has a work area for storing, for example, image data.

The data memory 84 is configured with a rewritable nonvolatile memory. The data memory 84 corresponds to an auxiliary storage part of the computer, such as the controller 13. The data memory 84 is configured within a storage device, such as an electric erasable programmable read-only memory (EEPROM), a hard disk drive (HDD), or a solid state drive (SSD). The data memory 84 stores data such as setting data used for allowing the processor 81 to execute various processes. The data memory 84 stores data generated through the process executed by the processor 81. The data memory 84 may store the application program.

The controller 13 controls the image forming mechanism 20. For example, the controller 13 controls each of the process units (e.g., image forming stations) 41, the exposure unit (e.g., exposure device) 42, and the transfer mechanism 43. For example, the controller 13 controls the charging unit (e.g., charger) 52 of each of the process units (e.g., image forming stations) 41 to start or stop charging. The controller 13 controls the exposure unit (e.g., exposure device) 42 of each of the process units (e.g., image forming stations) 41 to start or stop irradiation of laser light with which the photoconductive drum 51 is irradiated. As a result, an electrostatic latent image is formed on the photoconductive drum 51.

The controller 13 controls the developing unit (e.g., developer) 53 of each of the process units (e.g., image forming stations) 41 to start or stop application of a developing bias. As a result, the electrostatic latent image on the photoconductive drum 51 is developed with the toner supplied from the developing unit (e.g., developer) 53 to form a toner image on the photoconductive drum 51. The controller 13 controls the transfer mechanism 43 to apply a primary transfer bias at each of the primary transfer positions. The toner image on the photoconductive drum 51 is transferred to the primary transfer belt 61 at the primary transfer position. The controller 13 controls the transfer mechanism 43 to apply a secondary transfer bias at each of the secondary transfer positions. As a result, the toner image on the primary transfer belt 61 is transferred to the printing medium P.

The controller 13 controls the fixing device including the fixing unit (e.g., fixer) 21. The controller 13 also controls the operations of the center heater 731 and the side heater 732 by the heater control circuit 14 based on the detection results of the temperature sensor 741 and the temperature sensor 742. The heater control circuit 14 operates in response to a control instruction from the controller 13 to control the energization to the center heater 731 and the side heater 732. A part or all of the configuration of the heater control circuit 14 described below may be included in the controller 13.

The heater control circuit 14 controls the energization to the center heater 731 and the side heater 732 such that the surface of the heating roller 71 reaches a set target temperature. For example, the controller 13 sets the heater control circuit 14 to a target value (e.g., control target temperature). The heater control circuit 14 supplies power to the center heater 731 with reference to the temperature detected by the temperature sensor 741 such that the center region C of the heating roller 71 reaches a target value of the center. The heater control circuit 14 supplies power to the side heater 732 with reference to the temperature detected by the temperature sensor 742 such that the side region S of the heating roller 71 reaches a target value of the side.

When the temperature of the center region C of the heating roller 71 reaches a set high-temperature stop temperature of the center, the heater control circuit 14 interrupts power supply to the center heater 731. When the temperature of the side region S of the heating roller 71 reaches a set high-temperature stop temperature of the side, the heater control circuit 14 interrupts power supply to the side heater 732. In the heater control circuit 14, the high-temperature stop temperature of the center and the high-temperature stop temperature of the side are set and corrected by the controller 13.

Next, a control of the heater 73 of the fixing unit (e.g., fixer) 21 in the image forming apparatus 1 according to at least one embodiment will be described.

In the image forming apparatus 1, including the fixing device, also includes the heater 73 of the fixing unit (e.g., fixer) 21. The heater 73 is controlled by a weighted average control with estimate temperature (WAE) control. The WAE control is a control assuming that heat transfer in the fixing unit (e.g., fixer) 21 is equivalently represented by a CR time constant of an electric circuit. In the WAE control, it is assumed that the thermal capacity of the fixing unit 21 is represented by C, the resistance of the heat transfer is represented by R, and a circuit (e.g., thermal CR circuit) including a direct current voltage source as a heat source is used.

That is, the thermal capacity of the fixing unit 21 in the thermal CR circuit is replaced with a capacitor C. The resistance of the heat transfer is replaced with a resistor R. The heat source is replaced with a direct current voltage source. The thermal CR circuit is a circuit that operates in response to an input voltage pulse. The thermal CR circuit operates in response to the input voltage pulse where energization and interruption of power from the direct current voltage source are repeated based on an energization pulse. The thermal CR circuit applies heat generated as an output voltage to the heating member.

In the thermal CR circuit, a value (e.g., C and R) of each of the elements is set based on the amount of energization to the heating member, the thermal capacity of the fixing rotating body, and the like. The amount of heat transferred to the surface of the fixing rotating body that is a control target can be estimated based on the thermal CR circuit. By simulating the WAE control as the thermal CR circuit, the amount of energization of the heating member is controlled based on the actual surface temperature of the fixing rotating body estimated from input energy or the like to the fixing unit. Through the WAE control, in the fixing device in the image forming apparatus 1 according to the embodiment, the surface temperature of the fixing rotating body is controlled to a target value.

In the image forming apparatus 1, the actual input voltage (e.g., input energy) can be specified by the power supply voltage detection device 23. As a result, in the image forming apparatus 1, the operation can be controlled using the actual input voltage in the WAE control.

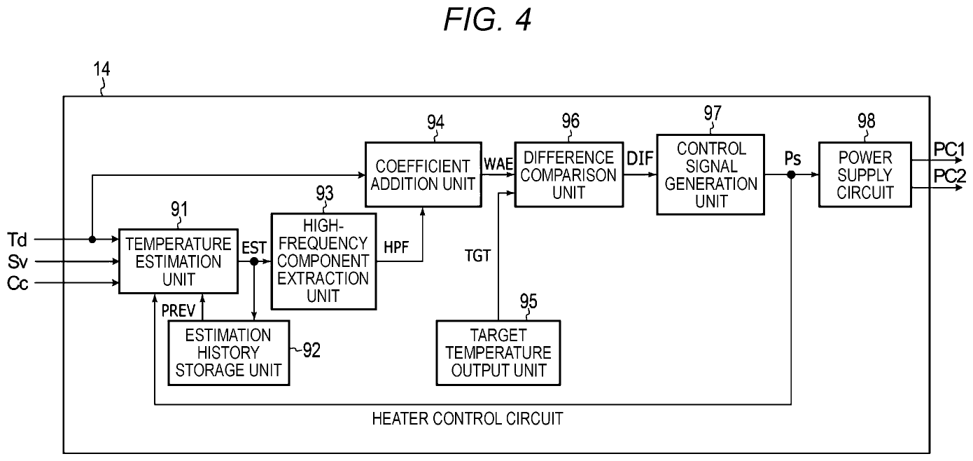

FIG. 4 is a diagram illustrating a configuration of the heater control circuit 14 in the image forming apparatus 1 according to an embodiment that executes the WAE control.

In the configuration example illustrated in FIG. 4, the heater control circuit 14 controls the energization to the heater 73 of the fixing unit (e.g., fixer) 21. The heater control circuit 14 generates the energization powers PC1 and PC2 for energizing the heater 73 of the fixing unit 21. The heater control circuit 14 supplies power to the center heater 731 using the energization power PC1 and supplies power to the side heater 732 using the energization power PC2.

The heater control circuit 14 includes a temperature estimation unit 91, an estimation history storage device 92, a high-frequency component extraction device 93, a coefficient addition device 94, a target temperature output device 95, a difference comparison device 96, a control signal generation device 97, and a power supply circuit 98. A temperature detection result Td from the temperature sensor 74 and the power supply voltage detection result Sv stored in the data memory 84 or the like of the controller 13 are input to the heater control circuit 14.

The temperature estimation unit 91 executes a temperature estimation process of estimating the temperature (e.g., a WAE estimated value) of the surface of the heating roller 71. In the configuration example illustrated in FIG. 4, the temperature detection result Td from the temperature sensor 74, the power supply voltage detection result Sv, an estimation history PREV, and an energization pulse Ps are input to the temperature estimation device 91. The temperature estimation device 91 estimates the WAE estimated value based on the temperature detection result Td, the power supply voltage detection result Sv, the estimation history PREV, and the energization pulse Ps. The temperature estimation device 91 outputs the WAE estimated value that is an estimated temperature estimation result EST.

The temperature estimation device 91 estimates the amount of heat applied to the heating roller 71 using the thermal CR circuit where the value of each of the elements is preset based on the amount of energization to the heater 73, the thermal capacity of the heating roller 71, and the like. The temperature estimation device 91 generates the temperature estimation result EST based on the estimated amount of heat applied to the heating roller 71, the temperature detection result Td, the power supply voltage detection result Sv, the estimation history PREV, and the energization pulse Ps. The temperature estimation device 91 outputs the temperature estimation result EST to the estimation history storage device 92 and the high-frequency component extraction device 93.

In the embodiment, the temperature estimation device 91 estimates (e.g., calculates) each of a center WAE estimated value ct and a side WAE estimated value st as the temperature estimation result EST. The center WAE estimated value ct is an estimated value of the temperature of the surface in the center region C of the heating roller 71. The side WAE estimated value st is an estimated value of the temperature of the surface in the side region of the heating roller 71. The temperature estimation device 91 supplies the center WAE estimated value ct and the side WAE estimated value st to the controller 13.

The estimation history storage device 92 stores a history of the temperature estimation result EST. The estimation history storage device 92 outputs the estimation history PREV that is the history (e.g., the previous temperature estimation result EST) of the temperature estimation result EST to the temperature estimation device 91.

The high-frequency component extraction device (e.g., extractor) 93 executes a high pass filtering process of extracting a high-frequency component of the temperature estimation result EST. The high-frequency component extraction device 93 outputs a high-frequency component HPF that is a signal representing the extracted high-frequency component to the coefficient addition device 94.

The coefficient addition device 94 that is configured to perform a coefficient addition process. The coefficient addition process is correction of the temperature detection result Td. The temperature detection result Td from the temperature sensor 74 and the high-frequency component HPF from the high-frequency component extraction device 93 are input to the coefficient addition device 94. The coefficient addition device 94 corrects the temperature detection result Td based on the high-frequency component HPF. Specifically, the coefficient addition unit 94 multiplies the high-frequency component HPF and the preset coefficient by each other and adds the obtained value to the temperature detection result Td to calculate a corrected temperature value WAE. The coefficient addition device 94 outputs the corrected temperature value WAE to the difference comparison device 96. The coefficient addition device 94 also outputs the corrected temperature value WAE to the processor 81 of the controller 13.

The target temperature output device 95 outputs a set target temperature TGT to the difference comparison device 96. In the target temperature output device 95, the target temperature TGT is set by the controller 13.

The difference comparison device 96 executes a difference calculation process. The difference comparison device 96 calculates a difference DIF between the target temperature TGT from the target temperature output device 95 and the corrected temperature value WAE from the coefficient addition device 94. The difference comparison device 96 outputs the calculated difference DIF to the control signal generation device 97.

The control signal generation device 97 generates the energization pulse Ps that is a pulse signal for controlling energization to the heater 73 based on the difference DIF. The control signal generation device 97 outputs the energization pulse Ps to the power supply circuit 98 and the temperature estimation device 91.

The power supply circuit 98 supplies the energization powers PCI and PC2 to the heater 73 based on the energization pulse Ps. The power supply circuit 98 energizes the heater 73 of the fixing unit (e.g., fixer, fixing device) 21 using the direct current power supply voltage Vdc supplied from the power converter circuit 22. For example, based on the energization pulse Ps, the power supply circuit 98 switches between a state where the direct current power supply voltage Vdc from the power converter circuit 22 is supplied to the heater 73 and a state where the direct current power supply voltage Vdc from the power converter circuit 22 is not supplied to the heater 73. As a result, the power supply circuit 98 supplies the energization powers PCI and PC2 to the heater 73. In other words, the power supply circuit 98 can change an energization time to the heater 73 of the fixing unit (e.g., fixer, fixing device) 21 depending on the energization pulse Ps.

A lighting control signal corresponding to the size of the printing medium P as a fixed (e.g., set, etc.) target is input from the processor 81 of the controller 13 to the power supply circuit 98. The power supply circuit 98 supplies the energization power PC1 or both of the energization powers PC1 and PC2 to the heater 73 depending on the lighting control signal from the processor 81, that is, the size of the printing medium P.

The power supply circuit 98 may be configured to be integrated with the fixing unit 21. The heater control circuit 14 may be configured to supply the energization pulse Ps to the power supply circuit of the heater 73 of the fixing unit (e.g., fixer, fixing device) 21 instead of supplying the energization power PC to the heater 73.

As described above, the heater control circuit 14 adjusts the amount of power to the heater 73 of the fixing unit (e.g., fixer, fixing device) 21 based on a thermal capacity correction amount Cc, the temperature detection result Td, the power supply voltage detection result Sv, the temperature estimation history PREV, and the energization pulse Ps such that the surface temperature of the heating roller reaches the target temperature. As a result, the heater control circuit 14 can control the power supplied to the heater 73 such that the surface temperature of the heating roller 71 reaches the target temperature.

Each of the temperature estimation device 91, the estimation history storage unit 92, the high-frequency component extraction device 93, the coefficient addition device 94, the target temperature output device 95, the difference comparison device 96, and the control signal generation device 97 in the heater control circuit 14 may be configured with an electric circuit or may be configured with software. A part or all of the configuration of the heater control circuit 14 may be included in the controller 13. For example, the controller 13 may be configured to calculate (e.g., estimate) the center WAE estimated value and the side WAE estimated value as the WAE estimated value.

As the thermal capacity C of the fixing unit (e.g., fixer) 21 used in the WAE control, a design reference value may be used. In the WAE control using the design reference value, the thermal capacity of the fixing unit (e.g., fixer) 21 may vary depending on apparatuses. Therefore, the thermal capacity correction amount Cc for the thermal capacity C may be set. For example, in the image forming apparatus 1, a correction amount table representing the thermal capacity correction amount Cc may be provided as the correction amount for the thermal capacity C in the data memory 84.

The correction amount table stores the thermal capacity correction amount corresponding to a temperature difference set depending on apparatuses of the image forming apparatus 1. The temperature difference is a difference between the temperature of the heater of the fixing unit (e.g., fixer) 21 that is estimated when the heater control circuit 14 sets the thermal capacity correction amount to “0” and the temperature of the heater that is actually measured.

When the thermal capacity correction amount Cc is also considered to estimate the temperature, the heater control circuit 14 acquires the thermal capacity correction amount Cc of the image forming apparatus 1 based on the correction amount table from the controller 13. When the thermal capacity correction amount Cc is input to the heater control circuit 14, the temperature estimation device 91 estimates the WAE estimated value based on the temperature detection result Td, the power supply voltage detection result Sv, the thermal capacity correction amount Cc, the estimation history PREV, and the energization pulse Ps. As a result, the temperature estimation device 91 can output the WAE estimated value as the temperature estimation result EST that is estimated using the thermal capacity correction amount Cc.

Next, a relationship between the estimated value (WAE estimated value) of the surface temperature of the heating roller 71 for the contamination of the contact portion of the temperature sensor 74 and the actual temperature of the heating roller 71 will be described.

Here, a ready state refers to a print waiting state. In the ready state, the controller 13 controls the surface temperature of the heating roller 71 to be maintained at a predetermined control target temperature. For example, when the image forming apparatus 1 starts, the controller 13 executes a warm-up operation of heating the heating roller 71 to a predetermined target temperature. When the heating roller 71 reaches the predetermined target temperature, the controller 13 shifts to the ready state such that the heating roller 71 is maintained at the predetermined control target temperature. A state where the image forming apparatus 1 is left in the ready state without executing printing will also be referred to as “left-ready state”.

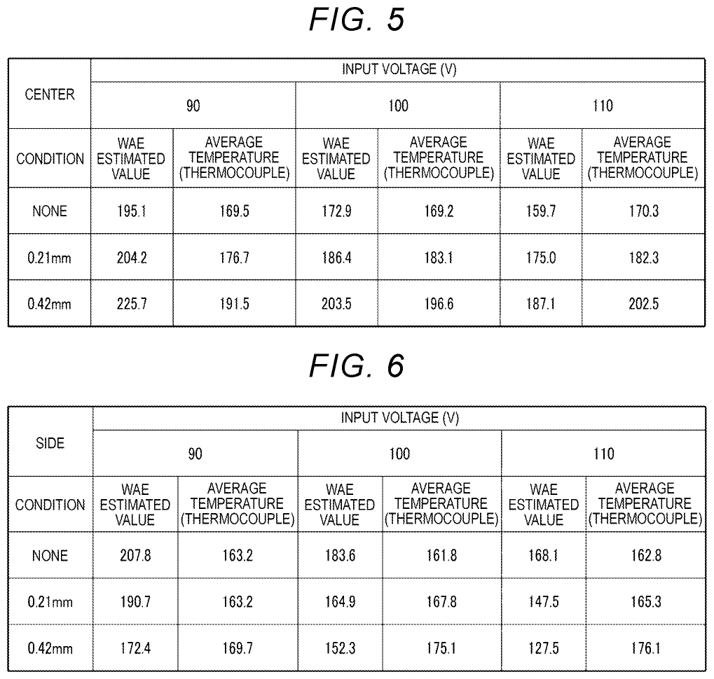

FIG. 5 illustrates a measurement example of the center WAE estimated value ct for each of the input voltages to the center heater 731 in three states (e.g., conditions) having different degrees of contamination and the actual temperature in the center region C of the heating roller 71.

The center WAE estimated value illustrated in FIG. 5 is the average value of the center WAE estimated values in a final period of about 20 seconds (e.g., about 40 seconds to about 60 seconds) when the maintenance (e.g., left-ready state) of the ready state is continued for about 1 minute. The average temperature (e.g., thermocouple) illustrated in FIG. 5 is the average value (e.g., measured value) of the actual surface temperatures in the center region C of the heating roller 71 in a final period of about 20 seconds (e.g., about 40 seconds to about 60 seconds) when the ready state is continued for about 1 minute.

In the measurement, it is assumed that, in the ready state, the control target temperature of the center region C of the heating roller 71 is about 160° C. and the control target temperature of the side region S of the heating roller 71 is about 155° C. Examples illustrated in FIGS. 6 to 8 described below illustrate numerical values or the like based on the result of measurement for a final measurement period of about 20 seconds when the ready state is continued for about 1 minute. The final period of about 20 seconds when the ready state is continued for about 1 minute is set assuming that the final period is a period of time where the control of maintaining the ready state after shifting to the ready state is stable.

The degree of contamination in the detection unit of the temperature sensor 74 is reproduced by attaching a tape (hereinafter, referred to as “pseudo contamination tape”) that is used to resemble contamination to the detection unit of the temperature sensor 74. The pseudo contamination tape is a heat-resistant tape that is formed of a material including polyimide as a base.

In the example illustrated in FIG. 5, the three conditions are contamination states of the detection unit of the temperature sensor 741 in contact with the center region C of the heating roller 71. “None” (referred to as “first condition”) in the condition represents a state (e.g., a state where there is no contamination) where the pseudo contamination tape is not attached to the contact portion of the temperature sensor 741. “0.21 mm” (referred to as “second condition”) in the condition represents a state where a pseudo contamination tape having a thickness of 0.21 mm is attached to the contact portion of the temperature sensor 741. “0.42 mm” (referred to as “third condition”) in the condition represents a state (e.g., a state where there is contamination) where a pseudo contamination tape having a thickness of 0.42 mm is attached to the contact portion of the temperature sensor 741.

The thickness (e.g., thickness corresponding to contamination) of the pseudo contamination tape may be reproduced by laminating a plurality of tapes having a specific thickness. For example, the tape having a thickness of about 0.21 mm in the second condition is formed by laminating and attaching three tapes having a thickness of about 0.07 mm to the contact portion of the temperature sensor 741. For example, the tape having a thickness of about 0.42 mm in the third condition is formed by laminating and attaching three tapes having a thickness of about 0.07 mm to the contact portion of the temperature sensor 74.

In the example illustrated in FIG. 5, when the input voltage is about 100 V, the center WAE estimated value is about 172.9° C. in the first condition, is about 186.4° C. in the second condition, and is about 203.5° C. in the third condition. When the input voltage is about 90 V, the center WAE estimated value is about 195.1° C. in the first condition, is about 204.2° C. in the second condition, and is about 225.7° C. in the third condition. When the input voltage is about 110 V, the center WAE estimated value is about 159.7° C. in the first condition, is about 175.0° C. in the second condition, and is about 187.1° C. in the third condition.

When the input voltage is about 100 V, the average temperature (e.g., the actual temperature of the center region) is about 169.2° C. in the first condition, is about 183.1° C. in the second condition, and is about 196.6° C. in the third condition. When the input voltage is about 90 V, the average temperature is about 169.5° C. in the first condition, is about 176.7° C. in the second condition, and is about 191.5° C. in the third condition. When the input voltage is about 110 V, the average temperature is about 170.3° C. in the first condition, is about 182.3° C. in the second condition, and is about 202.5° C. in the third condition.

In the example illustrated in FIG. 5, regardless of the value of the input voltage to the center heater 731, as the thickness of contamination increases, the center WAE estimated value increases. The actual surface temperature (e.g., the average temperature) of the center region C in the heating roller 71 also increases as the thickness of contamination increases, regardless of the value of the input voltage to the center heater 731.

FIG. 6 illustrates a measurement example of the side WAE estimated value st for each of the input voltages in the three conditions that are the same as those of FIG. 5 and the actual temperature in the side region S of the heating roller 71.

The side WAE estimated value st illustrated in FIG. 6 is the average value of the side WAE estimated values in a final period of about 20 seconds (e.g., about 40 seconds to about 60 seconds) when the maintenance (e.g., left-ready state) of the ready state is continued for about 1 minute. The average temperature (e.g., thermocouple) illustrated in FIG. 6 is the average value (e.g., the measured value) of the actual surface temperatures in the side region S of the heating roller 71 in a final period of about 20 seconds (e.g., about 40 seconds to about 60 seconds) when the ready state (e.g., l eft-ready state) is continued for about 1 minute.

In the example illustrated in FIG. 6, when the input voltage is about 100 V, the side WAE estimated value is about 183.6° C. in the first condition, is about 164.9° C. in the second condition, and is about 152.3° C. in the third condition. When the input voltage is about 90 V, the side WAE estimated value is about 207.8° C. in the first condition, is about 190.7° C. in the second condition, and is about 172.4° C. in the third condition. When the input voltage is about 110 V, the side WAE estimated value is about 168.1° C. in the first condition, is about 147.5° C. in the second condition, and is about 127.5° C. in the third condition.

In the example illustrated in FIG. 6, when the input voltage is about 100 V, the average temperature (e.g., the actual temperature of the side region) is about 161.8° C. in the first condition, is about 167.8° C. in the second condition, and is about 175.1° C. in the third condition. When the input voltage is about 90 V, the average temperature is about 163.2° C. in the first condition, is about 163.2° C. in the second condition, and is about 169.7° C. in the third condition. When the input voltage is about 110 V, the average temperature is about 162.8° C. in the first condition, is about 165.3° C. in the second condition, and is about 176.1° C. in the third condition.

That is, in the example illustrated in FIG. 6, regardless of the value of the input voltage to the center heater 731, as the thickness of contamination increases, the side WAE estimated value st decreases. The actual surface temperature (e.g., the average temperature) of the side region S in the heating roller 71 increases as the thickness of contamination increases, regardless of the value of the input voltage to the center heater 731.

In FIGS. 5 and 6, as the degree of contamination in the contact portion of the temperature sensor 741 of the center region increases, the center WAE estimated value ct increases, and the side WAE estimated value st decreases. Since the temperature detected by the temperature sensor 741 is lower than the actual temperature due to the contamination, the number of times the center heater 731 is turned on is more than that of the control corresponding to the actual temperature. When the number of times the center heater 731 is turned on increases, heat in the center region flows to the side region such that the number of times the side heater 732 is turned on decreases. As a result, the center WAE estimated value ct increases, but the side WAE estimated value st decreases.

As described above, only when the detection unit of the temperature sensor 741 is contaminated, the center WAE estimated value ct increases, and the side WAE estimated value st decreases. When only the detection unit of the temperature sensor 741 in contact with the center region is contaminated, a difference t between the WAE estimated values defined by ct−st=t is large. By setting a threshold for detecting the contamination of the center region (e.g., the detection unit of the temperature sensor 741) with respect to the difference t between the WAE estimated values, the controller can determine that the detection unit of the temperature sensor 741 is contaminated. According to the measurement results illustrated in FIGS. 5 and 6, a threshold for estimating an increase in actual temperature with respect to the detection temperature of the temperature sensor 741 can be set from the difference t between the WAE estimated values.

On the other hand, as the degree of contamination in the contact portion of the temperature sensor 742 of the side region S increases, the center WAE estimated value ct decreases, and the side WAE estimated value st increases. The reason is that the temperature detected by the temperature sensor 742 is lower than the actual temperature due to the contamination. Here, the difference t between the WAE estimated values defined by ct−st=t decreases (e.g., increases negatively) as the degree of contamination in the detection unit of the temperature sensor 742 increases. By setting a threshold for detecting the contamination of the side region (e.g., the contact portion of the temperature sensor 742) with respect to the difference t between the WAE estimated values, the controller can determine that the detection unit of the temperature sensor 742 is contaminated.

When both of the detection unit of the temperature sensor 741 and the detection unit of the temperature sensor 742 are contaminated, both of the center WAE estimated value and the side WAE estimated value are large. An upper limit value is set for each of the center WAE estimated value and the side WAE estimated value. For example, the upper limit value (e.g., first upper limit value) for the center WAE estimated value ct is set to about 190° C., and the upper limit value (e.g., second upper limit value) for the side WAE estimated value is set to about 180° C. By setting the first and second upper limit values, when the center WAE estimated value is the first upper limit value or higher and the side WAE estimated value is the second upper limit value, the contamination in both of the detection units of the temperature sensors can be estimated.

Next, a relationship of the difference t between the center WAE estimated value ct and the side WAE estimated value st and an increase in actual temperature in the heating roller 71 (e.g., the center region C and the side region S) will be described.

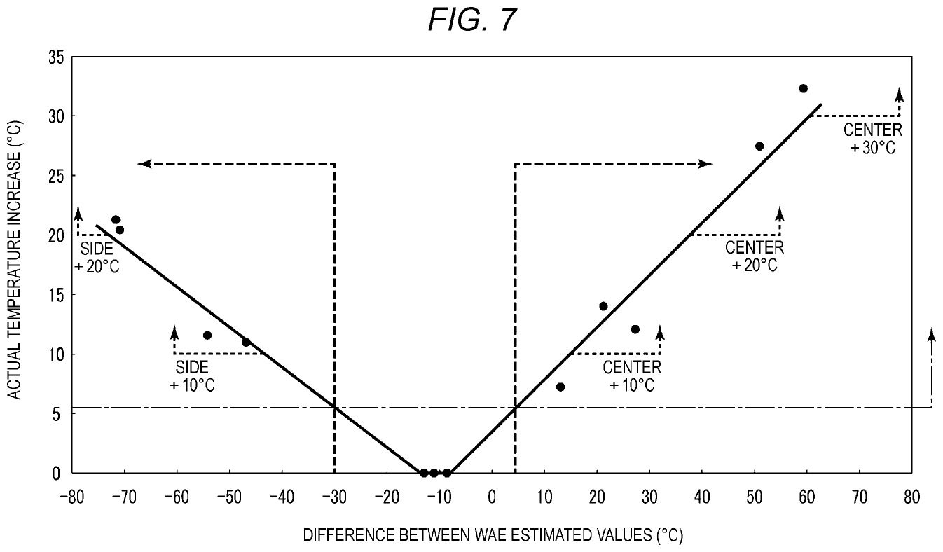

FIG. 7 is a diagram illustrating the relationship (e.g., the function) of the difference t between the center WAE estimated value ct and the side WAE estimated value st and an increase in actual temperature in the heating roller 71.

FIG. 7 illustrates the function representing the relationship of the difference between the WAE estimated values and an increase in actual temperature that is obtained from the value calculated based on the measurement result or the like corresponding to the contamination in the detection unit of the temperature sensor. FIG. 7 illustrates the relationship of the difference t between the center WAE estimated value ct and the side WAE estimated value st and the increase in actual temperature in the heating roller 71 in the final period of about 20 seconds when the left-ready state is continued for about 1 minute. Here, the increase in actual temperature represents a temperature difference between the temperature detected by the temperature sensor 74 and the actual temperature of the heating roller.

The difference (e.g., the difference between the WAE estimated values) t between the center WAE estimated value ct and the side WAE estimated value st is a value (e.g., t=ct−st) obtained by subtracting the side WAE estimated value st from the center WAE estimated value ct. When the difference t between the WAE estimated values is about −8° C. or higher, FIG. 7 illustrates an increase in actual temperature in the center region C, and when the difference t between the WAE estimated values is about −14° C. or lower, FIG. 7 illustrates an increase in actual temperature in the side region S.

FIG. 7 illustrates a setting example of a threshold for determining the increase in actual temperature in the center region C and the side region S. In the example illustrated in FIG. 7, as indicated by a dotted line in the drawing, when the difference t between the WAE estimated values is about 60° C. or higher, the controller can determine that the increase in actual temperature in the center region C is about 30° C. When the difference t between the WAE estimated values is in a range of about 37° C. or higher and lower than about 60° C., the controller can determine that the increase in actual temperature in the center region C is about 20° C. When the difference t between the WAE estimated values is in a range of about 15° C. or higher and lower than about 37° C., the controller can determine that the increase in actual temperature in the center region C is about 10°° C.

When the difference t between the WAE estimated values is in a range of higher than about −43° C. and lower than about 15° C., the controller can determine that the increases in actual temperature in the center region C and the side region S are in a normal range. When the difference t between the WAE estimated values is in a range of about −43° C. or lower and higher than about −73° C., the controller can determine that the increase in actual temperature in the side region S is about 10° C. When the difference t between the WAE estimated values is about −73° C. or lower, the controller can determine that the increase in actual temperature in the side region S is about 20° C.

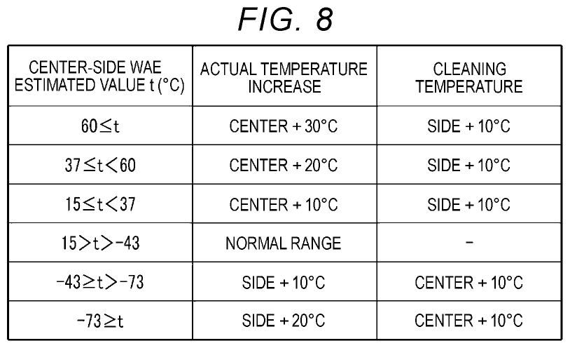

FIG. 8 is a diagram illustrating a table containing the determination results of the increase in actual temperature with respect to the difference t between the WAE estimated values illustrated in FIG. 7 and setting examples of the cleaning temperature are collected.

The table illustrated in FIG. 8 stores information representing the values of the increase in actual temperature with respect to the difference t between the WAE estimated values and the cleaning temperatures. The table illustrated in FIG. 8 is stored in, for example, the data memory 84. Separately from the table illustrated in FIG. 8, the data memory 84 also stores the cleaning temperatures when both of the contact portions of the two temperature sensors 741 and 742 are contaminated.

The cleaning temperature is the control target temperature of the center region C and the side region S of the heating roller 71 during cleaning of the fixing unit (e.g., fixer) 21. For example, when the cleaning temperature is “Center +10° C.”, the control target temperature of the center region C during the cleaning of the fixing unit is set to +10° C. with respect to the control target temperature (for example, 160° C.) in the ready state (print waiting state). When the cleaning temperature is “Side +10° C.”, the control target temperature of the side region S during the cleaning of the fixing unit is set to +10° C. with respect to the control target temperature (e.g., 155° C.) in the ready state.

In the table illustrated in FIG. 8, when the difference t between the WAE estimated values is 60° C. or higher (e.g., 60≥t), the controller determines (e.g., estimates) that the increase in actual temperature in the center region C is about 30° C. When the difference t between the WAE estimated values is in a range of about 37° C. or higher and lower than about 60° C. (e.g., a range of about 37≤t<60), the controller can determine that the increase in actual temperature in the center region C is about 20° C. When the difference t between the WAE estimated values is in a range of about 15° C. or higher and lower than about 37° C. (e.g., a range of about 15≤t<37), the controller can determine that the increase in actual temperature in the center region C is about 10° C.

When the difference t between the WAE estimated values is about 15° C. or higher (e.g., 15≤t), the cleaning temperature is “Side +10° C.”. When the cleaning temperature is “Side +10° C.”, the controller 13 sets the control target temperature of the side region S of the heating roller 71 to +10° C. to clean the fixing unit.

When the difference t between the WAE estimated values is in a range of higher than about −43° C. and lower than about 15° C. (e.g., a range of about −43<t<15), the controller can determine that the increases in actual temperature in the center region C and the side region are in the normal range. When the difference t between the WAE estimated values is in a range of about −43° C. or lower and higher than about −73° C. (e.g., a range of about −43≥t>−73), the controller can determine that the increase in actual temperature in the side region S is about 10° C. When the difference t between the WAE estimated values is about −73° C. or lower (e.g., −73≥t), the controller can determine that the increase in actual temperature in the side region S is about 20° C.

When the difference t between the WAE estimated values is about −43° C. or lower (e.g., −43≥t), the cleaning temperature is “Center +10° C.”. When the cleaning temperature is “Center +10° C.”, the controller 13 sets the control target temperature of the center region C of the heating roller 71 to +10° C. to clean the fixing unit.

The cleaning temperature may be set depending on the increase in actual temperature in each of the regions. For example, different cleaning temperatures may be set when the actual temperature of the side is +20° C. and when the actual temperature of the side is +10° C. Different cleaning temperatures may be set when the actual temperature of the center is +30° C., when the actual temperature of the center is +20° C., and when the actual temperature of the center is +10° C. When both of the detection unit of the temperature sensor 741 and the contact portion of the temperature sensor 742 are contaminated, the cleaning temperature may be set to a predetermined control target temperature in a normal state (e.g., a ready state) without any change.

The image forming apparatus 1 and the fixing unit (e.g., fixer, fixing device) 21 according to the embodiment determine the increase in actual temperature and the cleaning temperature based on the difference t between the WAE estimated values using the table illustrated in FIG. 8. For example, the controller 13 acquires the center WAE estimated value ct and the side WAE estimated value st in a predetermined measurement period e.g., a period of about 20 seconds between about 40 seconds to about 60 seconds) from the start of the ready state (e.g., the normal state). The controller 13 calculates the difference t between the WAE estimated values from the difference between the center WAE estimated value ct and the side WAE estimated value st. The controller 13 specifies the increase in actual temperature and the cleaning temperature corresponding to the calculated difference t between the WAE estimated values based on the table illustrated in FIG. 8.

Next, an operation example of a contamination prediction process including the cleaning operation of the fixing unit that is accompanied by the contamination prediction in the image forming apparatus 1 including the fixing unit (e.g., fixer, fixing device) 21 according to the embodiment will be described.

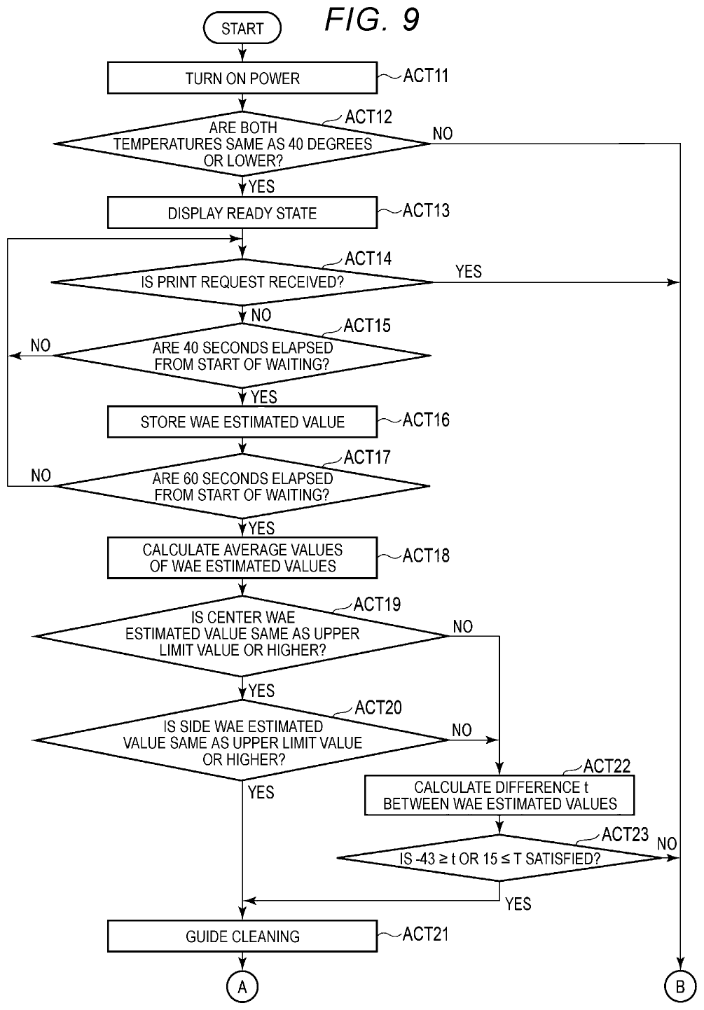

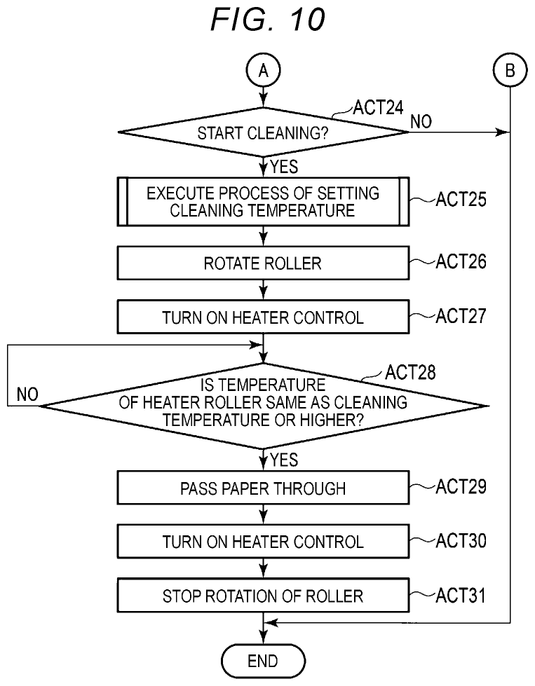

As shown in FIG. 9, the controller 13 executes the contamination prediction process by the processor 81 executing a program for the contamination prediction process. The program for the contamination prediction process that is executed by the processor 81 is stored in a nonvolatile memory such as the ROM 82 or the data memory 84.

The controller 13 turns on the power of the entire image forming apparatus 1 (ACT 11). When the power of the entire apparatus is turned on, the controller 13 acquires the temperature detected by the temperature sensor 741 and the temperature detected by the temperature sensor 742. The controller 13 checks whether both of the detection temperature of the temperature sensor 741 and the detection temperature of the temperature sensor 742 are 40 degrees or lower (ACT 12).

When any one of the detection temperature of the temperature sensor 741 or the detection temperature of the temperature sensor 742 exceeds 40 degrees (ACT 12, NO), the controller 13 skips the contamination prediction process. When the contamination prediction process is skipped, the controller 13 shifts to the normal operation.

When both of the detection temperature of the temperature sensor 741 and the detection temperature of the temperature sensor 742 are 40 degrees or lower (ACT 12, YES), the controller 13 executes a warm-up operation. When the warm-up operation is completed, the controller 13 shifts to the ready state and causes the display device 15 to display a guide representing that the apparatus is in the ready state (ACT 13).

When the controller 13 shifts to the ready state, the controller 13 receives a print request while counting the duration time of the left-ready state (e.g., the elapsed time from the shift to the ready state) (ACT 14). When the print request is received (ACT 14, YES), the controller 13 shifts to a printing process without executing the contamination prediction process.

When the print request is not received (ACT 14, NO), the controller 13 determines whether the duration time of the left-ready state reaches 40 seconds (e.g., the first time) that is a measurement start time of the WAE estimated values (ACT 15). When the duration time of the left-ready state does not reach 40 seconds (ACT 15, NO), the controller 13 returns to ACT 14 and receives the print request.

When the duration time of the left-ready state reaches 40 seconds (ACT 15, YES), the controller 13 starts the measurement of the WAE estimated values and acquires the center WAE estimated value ct and the side WAE estimated value st. The controller 13 stores the acquired center WAE estimated value ct and the acquired side WAE estimated value st in the memory such as the RAM 83 (ACT 16). In the embodiment, the controller 13 collects and stores the center WAE estimated value and the side WAE estimated value in the memory at predetermined intervals in the measurement period of the WAE estimation in the left-ready state (e.g., the period of 40 seconds to 60 seconds from the start of the left-ready state).

When the controller 13 stores the WAE estimated values, the controller 13 determines whether or not the duration time of the left-ready state reaches 60 seconds (e.g., the second time) that is a measurement end time of the WAE estimated values (ACT 17). When the duration time of the left-ready state does not reach 60 seconds (ACT 17, NO), the controller 13 returns to ACT 14. When the print request is not received, the controller 13 repeatedly stores the WAE estimated values. As a result, the center WAE estimated values and the side WAE estimated values in the measurement period of the WAE estimated values are collected and stored in the memory.

When the duration time of the left-ready state reaches 60 seconds (ACT 17, YES), the controller 13 calculates the average value of the center WAE estimated values and the average value of the side WAE estimated values from the WAE estimated values stored in the memory (ACT 18). That is, the controller 13 calculates the average value of the center WAE estimated values and the average value of the side WAE estimated values in the measurement period (e.g., the period of 40 seconds to 60 seconds). The controller 13 specifies the center WAE estimated value ct and the side WAE estimated value st that are calculated as the average values in the measurement period.

When the center WAE estimated value ct is specified, the controller 13 determines whether the center WAE estimated value ct is the first upper limit value (e.g., 190° C.) or higher (ACT 19). When the center WAE estimated value ct is the first upper limit value or higher (ACT 19, YES), the controller 13 further determines whether or not the side WAE estimated value st is the second upper limit value (e.g., 180° C.) or higher (ACT 20). When the side WAE estimated value is the second upper limit value or higher (ACT 20, YES), the controller 13 guides the cleaning of the fixing unit (ACT 21).

When the center WAE estimated value is the first upper limit value or higher and the side WAE estimated value is the second upper limit value, the controller 13 determines that both of the detection unit of the temperature sensor 741 and the detection unit of the temperature sensor 742 are contaminated. Here, the controller 13 causes the display device 15 to display a guide to clean the fixing unit. For example, the controller 13 urges a user to clean the fixing unit by causing the display device 15 to display a guide “Do you want to clean the fixing unit?”. When the display device 15 displays the guide to recommend the cleaning of the fixing unit, the controller 13 receives an instruction to clean the fixing unit from the user through the operation device.

When both of the center WAE estimated value and the side WAE estimated value are the upper limit values or higher, the controller 13 may output, to a service person, information representing that the entire heating roller 71 (e.g., the contact portion of each of the temperature sensors in contact with the heating roller 71) is contaminated via the communication interface 12.

When the center WAE estimated value is not the first upper limit value or higher (ACT 19, NO) or when the side WAE estimated value is not the second upper limit value or higher (ACT 20, NO), the controller 13 calculates the difference t between the center WAE estimated value ct and the side WAE estimated value st (ACT 22). For example, the processor 81 of the controller 13 calculates the difference t between the WAE estimated values by subtracting the side WAE estimated value st from the center WAE estimated value ct.

When the difference t between the WAE estimated values is calculated, the controller 13 determines whether to guide the cleaning of the fixing unit depending on the difference t between the WAE estimated values (ACT 23). For example, the controller 13 refers to the table illustrated in FIG. 8 to determine whether the difference t between the WAE estimated values is a value representing the contamination in the detection units of the temperature sensors 741 and 742. The controller 13 determines whether to guide the cleaning of the fixing unit depending on whether the detection unit of the temperature sensor 741 or 742 is contaminated. When the controller 13 determines to guide the cleaning of the fixing unit based on the difference t between the WAE estimated values (ACT 23, YES), the controller 13 proceeds to ACT 21 and guides the cleaning of the fixing unit.

In the example illustrated in FIG. 8, when the difference t between the WAE estimated values is −43° C. or lower (e.g., −43≥t), the controller 13 determines that the detection unit of the temperature sensor 742 in contact with the side region S is contaminated. When the controller 13 determines that the contact portion of the temperature sensor 742 is contaminated (e.g., the actual temperature of the side is high), the controller 13 causes the display device 15 to display a guide to clean the fixing unit (e.g., fixer, fixing device) 21 for removing the contamination.

In addition, when the difference t between the WAE estimated values is 15° C. or higher (15≤t), the controller 13 determines that the contact portion of the temperature sensor 741 in contact with the center region C is contaminated. When the controller 13 determines that the contact portion of the temperature sensor 741 is contaminated (e.g., the actual temperature of the center is high), the controller 13 causes the display device 15 to display a guide to clean the fixing unit for removing the contamination.

The controller 13 receives the instruction to clean the fixing unit after guiding the cleaning of the fixing unit. In response to the instruction, the user instructs whether or not to clean the fixing unit (e.g., fixer, fixing device) 21 through the operation device 16. The controller 13 determines whether to clean the fixing unit (e.g., fixer, fixing device) 21 depending on whether or not the instruction to clean the fixing unit (e.g., fixer, fixing device) 21 is given by the operation device 16 (ACT 24).

The controller 13 may determine whether to clean the fixing unit (e.g., fixer, fixing device) 21 regardless of the instruction of the user. For example, when the increase in actual temperature corresponding to the difference t between the WAE estimated values is a preset threshold or higher, the controller 13 may clean the fixing unit (e.g., fixer, fixing device) 21 even without the instruction of the user.

When the controller 13 determines not to clean the fixing unit (e.g., fixer, fixing device) 21 (ACT 24, NO), the controller 13 shifts to the normal operation (e.g., the ready state).

When the controller 13 determines to clean the fixing unit (e.g., fixer, fixing device) 21 (ACT 24, YES), the controller 13 executes a process of setting the cleaning temperature for the cleaning of the fixing unit (e.g., fixer, fixing device) 21 (ACT 25). The cleaning temperature represents the control target temperature (e.g., the target value for cleaning) of each of the regions of the heating roller 71 during the cleaning operation of the fixing unit (e.g., fixer, fixing device) 21. For example, in the table illustrated in FIG. 8, the cleaning temperature corresponding to the difference t between the WAE estimated values is set.

The cleaning operation of the fixing unit (e.g., fixer, fixing device) 21 (ACT 26 to ACT 31) is executed to remove the contamination in the detection units of the temperature sensors 741 and 742 in contact with the heating roller 71. The contact portions of the temperature sensors 741 and 742 may come into contact with the surface of the heating roller 71 in contact with the toner image on the paper such that the toner is attached to the contact portions. That is, the main contamination attached to the contact portions of the temperature sensor 74 is the toner. The toner attached as the contamination to the contact portions of the temperature sensor 74 melts with heat. During the cleaning of the fixing unit (e.g., fixer, fixing device) 21, the toner remaining as the contamination melts with heat and is attached to the paper to be removed.

That is, the cleaning temperature is set to accelerating the melting of the toner remaining as the contamination to the contact portion or the like of the temperature sensor 74 in contact with the heating roller 71. The contamination in the detection units of the temperature sensors 741 and 742 is specified from the difference t between the WAE estimated values as described above. In the setting example illustrated in FIG. 8, the cleaning temperature is set depending on the increase in actual temperature (e.g., the degree of contamination in the detection unit of the temperature sensor) that is specified from the difference t between the WAE estimated values.

When the detection unit of the temperature sensor 741 in contact with the center region C is contaminated, the actual temperature of the center region C increases. When the center WAE estimated value is higher than the side WAE estimated value, the control target temperature of the side region S as the cleaning temperature may be set to a value higher than the control target temperature of the side region in the ready state. In the setting example illustrated in FIG. 8, when the difference t between the WAE estimated values is 15° C. or higher, the control target temperature of the side region S as the cleaning temperature may be set to a value of +10° C. with respect to the control target temperature of the side region in the ready state.

When the detection unit of the temperature sensor 742 in contact with the side region S is contaminated, the actual temperature of the side region S increases. When the side WAE estimated value is higher than the center WAE estimated value, the control target temperature of the center region C as the cleaning temperature may be set to a value higher than the control target temperature of the center region in the ready state. In the setting example illustrated in FIG. 8, when the difference t between the WAE estimated values is about −43° C. or lower, the control target temperature of the center region as the cleaning temperature may be set to a value of +10° C. with respect to the control target temperature of the center region in the ready state.

Note that the toner melts even at the control target temperature (e.g., the normal control target temperature) in the normal state (e.g., the ready state). Therefore, the cleaning temperature may be set to the normal control target temperature without any change. The cleaning temperature may be set to a value that is variable (e.g., adjustable, tunable, etc.) with respect to the normal control target temperature depending on the increase in actual temperature caused by the contamination in the contact portion of the temperature sensor 741 or the temperature sensor 742.

For example, in a region where the actual temperature of the heating roller 71 is increased, actually, it is assumed that the cleaning temperature is controlled to a temperature obtained by adding the increase in actual temperature to the control target temperature. Therefore, as the increase in actual temperature specified from the difference t between the WAE estimated values increases, the temperature to be added to the normal control target temperature as the cleaning temperature may be set to decrease. For example, when the actual temperature of the center region C is increased by about 30° C., the cleaning temperature may be set to the normal control target temperature without any change.

When the cleaning temperature corresponding to the difference t between the WAE estimated values is specified, the controller 13 sets the target value for cleaning based on the specified cleaning temperature. As the target value for cleaning, the control target temperature of the center and the control target temperature of the side for the cleaning of the fixing unit (e.g., fixer, fixing device) 21 are set. When the target value for cleaning is set, the controller 13 rotates the heating roller 71 (ACT 26).

When the heating roller 71 rotates, the controller 13 turns on a heater control of controlling the heater such that each of the regions of the heating roller 71 reaches the target value for cleaning (ACT 27). As a result, the temperatures of the center region C and the side region S of the heating roller 71 increase up to the target value for cleaning (cleaning temperature).

When the temperature of the heating roller 71 is the target value for cleaning or higher (ACT 28), the controller 13 supplies paper (e.g., the medium) for attaching the residual toner to the fixing nip (ACT 29). When the heating roller 71 reaches the target value for cleaning, the residual toner as the contamination attached to the contact portion of the temperature sensor melts and moves to the fixing nip. The fixing nip is at a position where the paper, to which the toner image is transferred, passes in the normal fixing process. Therefore, when the residual toner in the contact portion of the temperature sensor 74 melts, the melted residual toner is attached to the paper passing through the fixing nip.

The paper passing through the fixing nip in the cleaning only has to be medium to which toner is attached, and is paper having a predetermined size that is set in the paper feed cassette. When the paper having the predetermined size is not present in the paper feed cassette, the controller 13 may output a guide such that the paper having the predetermined size is manually set.

When the supplied paper passes through the fixing nip, the controller 13 turns off the heater control of controlling the heating roller 71 to the target value for cleaning (ACT 30). When the paper passed through the fixing nip is discharged, the controller 13 stops the rotation of the heating roller 71 (ACT 31). As a result, the controller 13 completes the cleaning of the fixing unit (e.g., fixer, fixing device) 21 and shifts to the normal operation.

As described above, according to at least one embodiment, in the image forming apparatus 1, including the fixing unit (e.g., fixer, fixing device) 21, the contamination of the contact portion of the temperature sensor that is detected based on the difference between the WAE estimated values can be removed through the cleaning operation. As a result, in the image forming apparatus, the temperature sensor can detect the actual temperature, and failure such as high temperature offset or service call can be prevented in advance.

In the above-described embodiment, the image forming apparatus 1 including the fixing unit (e.g., fixer, fixing device) 21 according to at least the first configuration illustrated in FIGS. 1 and 2 is described. The configuration of the fixing unit (e.g., fixer, fixing device) 21 to be applied to the image forming apparatus 1 according to the this embodiment is not limited to the first configuration illustrated in FIGS. 1 and 2. Furthermore, the image forming apparatus 1 according to this embodiment, is not limited to the fixing unit (e.g., fixer, fixing device) 21 according to the first configuration, and fixing units (e.g., fixers, fixing devices) 21 according to the embodiments illustrated in FIG. 2 through FIG. 5 described below can be applied.

Hereinafter, modification examples of the fixing unit (e.g., fixer, fixing device) 21 that are applicable to the image forming apparatus 1 according to at least one embodiment will be described.

First, a fixing unit (e.g., a fixer, fixing device, etc.) 200 as a second example of the fixing unit (e.g., a fixer, fixing device) 21, that may be included the image forming apparatus 1, according to at least one embodiment will be described.

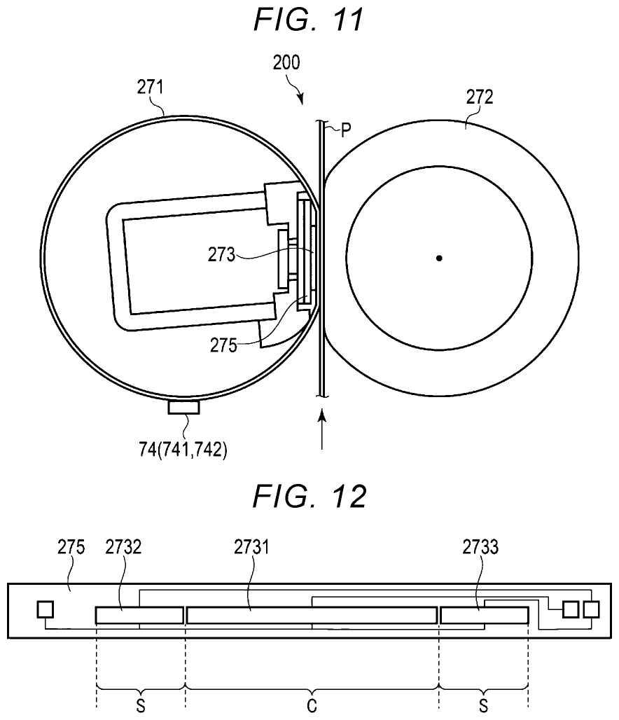

FIG. 11 is a diagram illustrating the configuration of the fixing unit (e.g., a fixer, fixing device) 200 as the second example of the fixing unit that is applicable to the image forming apparatus 1 according to at least one embodiment. FIG. 12 is a diagram illustrating a configuration of a heater in the fixing unit (e.g., a fixer, fixing device) 200.

As illustrated in FIG. 11, the fixing unit (e.g., a fixer, fixing device) 200 includes the temperature sensor 74 (e.g., 741, 742), a cylindrical film 271 as a fixing member (e.g., securing device), a pressurization roller 272, a heating element 273, and a heating element substrate 275. A nip is formed between the pressurization roller 272 and the cylindrical film 271. The cylindrical film 271 and the pressurization roller 272 pressurize and heat the printing medium P in the nip.

The heater includes the heating element 273 and the heating element substrate 275. The heating element substrate 275 may be formed of a metal material, a ceramic material, or the like. The heating element substrate 275 is formed in an elongated rectangular plate shape. The heating element substrate 275 is disposed inside the cylindrical film 271 in a radial direction. In the heating element substrate 275, an axis direction of the cylindrical film 271 is a longitudinal direction.

The heating element 273 includes a center heating element 2731, a first end heating element 2732, and a second end heating element 2733. The three heating elements 2731, 2732, and 2733 are arranged in parallel in a direction (e.g., the longitudinal direction of the heating element substrate 275) perpendicular to the paper conveying direction. The center heating element 2731 is arranged at a center position in a width direction of the printing medium P passing through the nip (the direction perpendicular to the conveying direction). The first end heating element 2732 and the second end heating element 2733 are arranged in parallel at opposite sides of the center heating element 2731.

The center heating element 2731 is an example of the first heat source. As illustrated in FIG. 12, the center heating element 2731 supplies heat mainly to the center region C in the direction perpendicular to the paper conveying direction. Note that, even when only the center heating element 2731 generates heat, the temperature of the side region S increases. The first end heating element 2732 and the second end heating element 2733 are examples of the second heat source. The first end heating element 2732 and the second end heating element 2733 supply heat mainly to the side region S in the direction perpendicular to the paper conveying direction as illustrated in FIG. 12.

The temperature sensors 741 and 742 are contact temperature detection devices such as a thermistor as in the first configuration illustrated in FIG. 1 and FIG. 2. The temperature sensor 741 detects the temperature of a position corresponding to the center region C that is heated by the center heating element 2731. The temperature sensor 742 detects the temperature of a position corresponding to the side region S that is heated by the end heating element 2732 or 2733.

As described above, for the fixing unit (e.g., a fixer, fixing device) 200 illustrated in FIGS. 11 and 12, the above-described WAE control can be executed. Therefore, even for the image forming apparatus 1 including the fixing unit (e.g., a fixer, fixing device) 200 illustrated in FIGS. 11 and 12, the process of guiding the cleaning of the fixing unit (e.g., a fixer, fixing device) 200 based on the WAE estimated values can be executed as described above. Note that the set values of the table illustrated in FIG. 8 cannot be applied to the image forming apparatus including the fixing unit (e.g., a fixer, fixing device) 200 as it is. The information such as the table illustrated in FIG. 8 representing the increase in actual temperature corresponding to the difference between the center WAE estimated value and the side WAE estimated value needs to be set depending on apparatuses of the image forming apparatus.

For example, in the image forming apparatus including the fixing unit (e.g., a fixer, fixing device) 200, the measurement of the characteristics illustrated in FIGS. 5 to 8 is executed. Based on the measurement result of the characteristics in the image forming apparatus including the fixing unit (e.g., a fixer, fixing device) 200, the increase in actual temperature corresponding to the difference between the center WAE estimated value and the side WAE estimated value is set. In the image forming apparatus including the fixing unit 200, the information representing the increase in actual temperature corresponding to the difference between the center WAE estimated value and the side WAE estimated value is stored (set) in the memory. As a result, for the image forming apparatus including the fixing unit 200, the process of guiding the cleaning of the fixing unit based on the increase in actual temperature (the contamination in the detection unit of the temperature sensor) determined from the WAE estimated values can be executed.

Next, a fixing unit 300 as a third example of the fixing unit that is applicable to the image forming apparatus 1 according to the embodiment will be described.

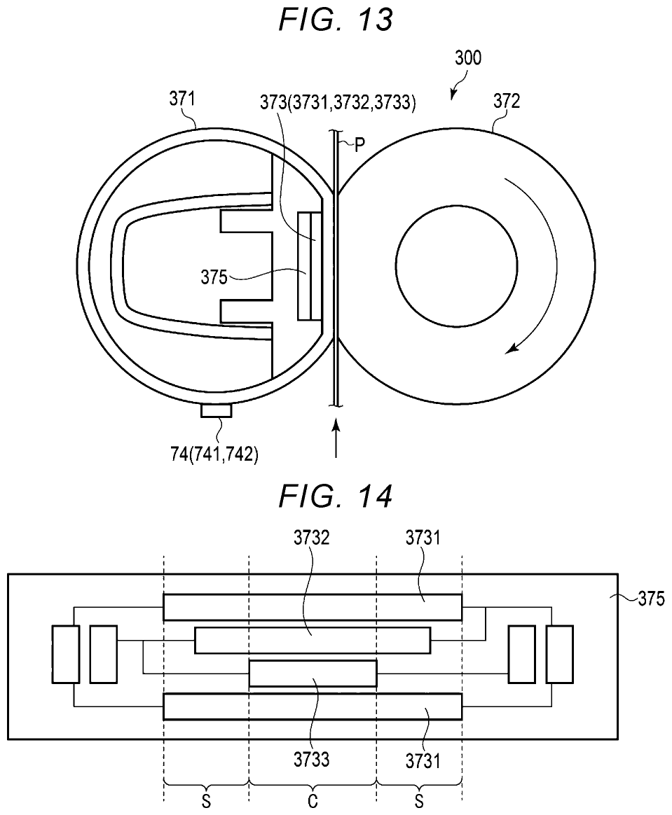

FIG. 13 is a diagram illustrating the configuration of the fixing unit (e.g., a fixer, fixing device) 300 as the third example of the fixing unit that is applicable to the image forming apparatus 1 according to the embodiment. FIG. 14 is a diagram illustrating an example of a heater in the fixing unit (e.g., a fixer, fixing device) 300.

As illustrated in FIG. 13, the fixing unit (e.g., a fixer, fixing device) 300 includes the temperature sensor 74 (741, 742), a cylindrical film 371 as a fixing member (e.g., a fixing rotating body), a pressurization roller 372, a heating element 373, and a heating element substrate 375. A nip is formed between the pressurization roller 372 and the cylindrical film 371. The cylindrical film 371 and the pressurization roller 372 pressurize and heat the printing medium P in the nip.

The heater unit includes the heating element 373 and the heating element substrate 375. The heating element substrate 375 is formed of a metal material, a ceramic material, or the like. The heating element substrate 375 is formed in an elongated rectangular plate shape. The heating element substrate 375 is disposed inside the cylindrical film 371 in a radial direction. In the heating element substrate 375, an axis direction of the cylindrical film 271 is a longitudinal direction.

The heating element 373 includes a plurality of heating elements 3731, 3732, and 3733. The heating element 373 is provided in contact with an inner surface of the cylindrical film 371 while the heating element 373 is disposed in the heating element substrate 375. Each of the heating elements 3731, 3732, and 3733 is a resistor that generates heat by power supply from an alternating current power supply.

The heating element 3731 is used for fixing toner to the printing medium P having a maximum width (e.g., the paper width) in a direction perpendicular to the conveying direction. The heating element 3731 has a width corresponding to the maximum paper width. The heating element 3731 is disposed on the upstream side and the downstream side in the conveying direction of the printing medium P in the heating element substrate 375.

The heating element 3732 is a heating element having a shorter width than the heating element 3731 in the direction perpendicular to the conveying direction of the printing medium P. The heating element 3733 is a heating element having a shorter width than the heating element 3732 in the direction perpendicular to the conveying direction of the printing medium P. The heating element 3731 is a main heater, and the heating elements 3732 and 3733 are sub-heaters. The main heater and the sub-heaters are controlled to be turned on and off depending on the paper width of the printing medium P.

As described above, for the fixing unit (e.g., a fixer, fixing device) 300 illustrated in FIGS. 13 and 14, the above-described WAE control can be executed. Therefore, the image forming apparatus 1, including the fixing unit (e.g., a fixer, fixing device) 300 illustrated in FIGS. 13 and 14, can perform the process of guiding the cleaning of the fixing unit based on the WAE estimated values can be executed as described above. In the image forming apparatus 1 including the fixing unit (e.g., a fixer, fixing device) 300, the information, as shown in the table illustrated in FIG. 8, representing the increase in actual temperature corresponding to the difference between the center WAE estimated value and the side WAE estimated value needs to be set. For example, in the image forming apparatus 1 including the fixing unit (e.g., a fixer, fixing device) 300, based on the result of the measurement of the characteristics illustrated in FIGS. 5 to 8, the information representing the increase in actual temperature corresponding to the difference between the center WAE estimated value and the side WAE estimated value is stored (e.g., set) in the memory. As a result, for the image forming apparatus 1 including the fixing unit (e.g., a fixer, fixing device) 300, the process of guiding the cleaning based on the increase in actual temperature (e.g., the contamination in the contact portion of the temperature sensor) determined from the WAE estimated values can be executed.

Next, a fixing unit (e.g., a fixer, fixing device) 400, as a fourth example of the fixing unit that may be included in the image forming apparatus 1 according to at least one embodiment will be described.

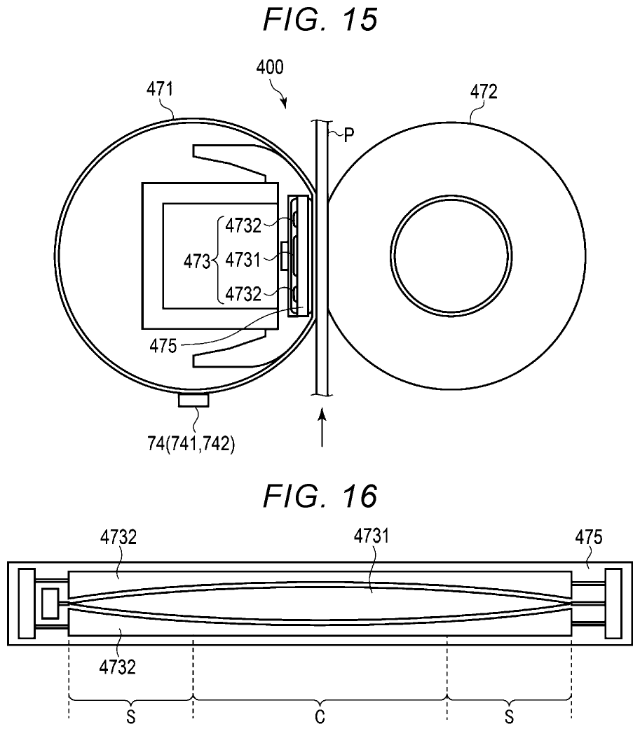

FIG. 15 is a diagram illustrating the configuration example of the fixing unit (e.g., a fixer, fixing device) 400 as the fourth example of the fixing unit that may be included in the image forming apparatus 1 according to at least one embodiment. FIG. 16 is a diagram illustrating a configuration of a heater positioned in the fixing unit (e.g., a fixer, fixing device) 400.

As illustrated in FIG. 15, the fixing unit (e.g., a fixer, fixing device) 400 includes the temperature sensor 74 (741, 742), a cylindrical film 471 as a fixing member (e.g., a fixed, rotatable body), a pressurization roller 472, a heating element 473, and a heating element substrate 475. A nip is formed between the pressurization roller 472 and the cylindrical film 471. The cylindrical film 471 and the pressurization roller 472 pressurize and heat the printing medium P in the nip.

The heater includes the heating element 473 and the heating element substrate 475. The heating element substrate 475 is formed of a metal material, a ceramic material, or the like. The heating element substrate 475 is formed in an elongated rectangular plate shape. The heating element substrate 475 is disposed inside the cylindrical film 471 in a radial direction. In the heating element substrate 475, an axis direction of the cylindrical film 471 is a longitudinal direction.

The heating element 473 includes a plurality of heating elements 4731 and 4732. The heating element 473 is provided in contact with an inner surface of the cylindrical film 471 while the heating element 473 is disposed in the heating element substrate 475. Each of the heating elements 4731 and 4732 is a resistor that generates heat by power supply from an alternating current power supply.

The heating element 4731 has a width corresponding to a maximum width of the printing medium P in a direction perpendicular to the conveying direction. As illustrated in FIG. 16, the heating element 4731 has a large width in the conveying direction at a center portion in the direction perpendicular to the conveying direction and has a small width in the conveying direction at an end portion. The heating element 4731 is a main heater configured to heat mainly the center region C. The heating element 4732 has a small width in the conveying direction at a center portion in the direction perpendicular to the conveying direction and has a large width in the conveying direction at an end portion. The heating element 4732 is a sub-heater configured to heat mainly the side region S. The main heater and the sub-heater are controlled to be turned on and off depending on the paper width of the printing medium P.

The fixing unit (e.g., a fixer, fixing device) 400 illustrated in FIGS. 15 and 16 and described above, may also execute the above-described WAE control. Therefore, the image forming apparatus 1 including the fixing unit (e.g., a fixer, fixing device) 400 illustrated in FIGS. 15 and 16, may perform the process of guiding the cleaning of the fixing unit based on the WAE estimated values can be executed as described above. In the image forming apparatus 1, including the fixing unit (e.g., a fixer, fixing device) 400, information, such as in the table illustrated in FIG. 8, representing the increase in actual temperature corresponding to the difference between the center WAE estimated value and the side WAE estimated value needs to be set. In the image forming apparatus 1, including the fixing unit 400, based on the result of the measurement of the characteristics illustrated in FIGS. 5 to 8, the information representing the increase in actual temperature corresponding to the difference between the center WAE estimated value and the side WAE estimated value is stored (e.g., set) in the memory. As a result, even for the image forming apparatus 1, including the fixing unit 400, the process of guiding the cleaning of the fixing unit based on the WAE estimated values can be executed.

Next, a fixing unit (e.g., a fixer, fixing device) 500 as a fifth example of the fixing unit that is applicable to the image forming apparatus 1 according to another embodiment will be described.

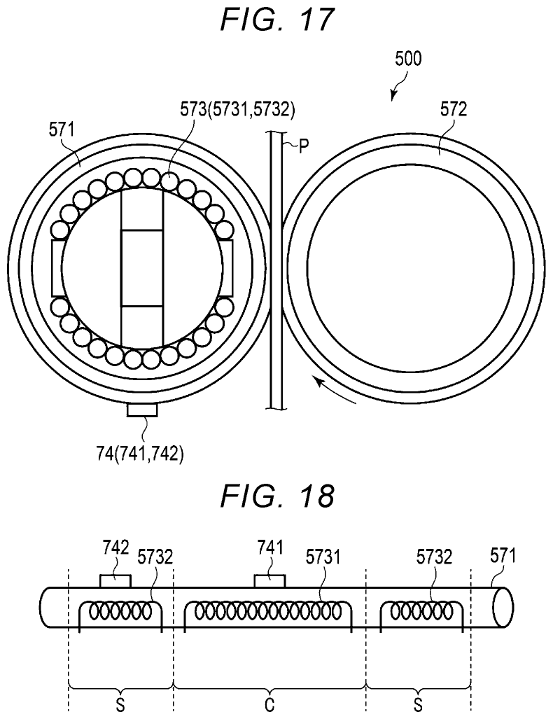

FIG. 17 is a diagram illustrating the configuration of the fixing unit (e.g., a fixer, fixing device) 500 as the fifth example of the fixing unit that is applicable to the image forming apparatus 1 according to another embodiment. FIG. 18 is a diagram illustrating a configuration of a heater in the fixing unit (e.g., a fixer, fixing device) 500.

As illustrated in FIG. 17, the fixing unit (e.g., a fixer, fixing device) 500 includes the temperature sensor 74 (741, 742), a heating roller 571 as a fixing member (e.g., a fixed, rotatable body), a pressurization roller 572, and an induction heating coil 573. A nip is formed between the pressurization roller 572 and heating roller 571. The heating roller 571 and the pressurization roller 572 pressurize and heat the printing medium P in the nip.

The induction heating coil 573 is an example of the heat source that heats the heating roller 571 as the fixing member. The induction heating coil 573 includes a center coil 5731 and an end coil 5732. The center coil 5731 and the end coil 5732 are arranged in parallel in a direction (e.g., a rotation axis direction of the heating roller 571) perpendicular to the paper conveying direction in the heating roller 571. The center coil 5731 is arranged at a center position in a width direction of the printing medium P passing through the nip (e.g., the direction perpendicular to the conveying direction). The end coils 5732 are arranged in parallel at opposite ends of the center coil 5731.

The center coil 5731 is an example of the first heat source. As illustrated in FIG. 18, the center coil 5731 supplies heat mainly to the center region C of the heating roller 571 in the direction perpendicular to the paper conveying direction. The end coil 5732 is an example of the second heat source. As illustrated in FIG. 18, the end coil 5732 supplies heat mainly to the side region S of the heating roller 571 in the direction perpendicular to the paper conveying direction.

The temperature sensors 741 and 742 are contact temperature detection devices such as a thermistor as in the fixing unit 21 according to the first configuration example. The temperature sensor 741 detects the temperature of the center region C of the heating roller 571. The temperature sensor 742 detects the temperature of the side region S of the heating roller 571.

As described above in at least one embodiment, the fixing unit 500 illustrated in FIGS. 17 and 18, may execute the above-described WAE control. Therefore, the image forming apparatus 1, including the fixing unit (e.g., a fixer, fixing device) 500 illustrated in FIGS. 17 and 18, can perform the process of guiding the cleaning of the fixing unit based on the WAE estimated values can be executed as described above. In the image forming apparatus 1, including the fixing unit (e.g., a fixer, fixing device) 500, the information, such as in the table illustrated in FIG. 8 representing the increase in actual temperature corresponding to the difference between the center WAE estimated value and the side WAE estimated value, needs to be set. In the image forming apparatus including the fixing unit (e.g., a fixer, fixing device) 500, based on the result of the measurement of the characteristics illustrated in FIGS. 5 to 8, the information representing the increase in actual temperature corresponding to the difference between the center WAE estimated value and the side WAE estimated value is stored (e.g., set) in the memory. As a result, even for the image forming apparatus 1, including the fixing unit 500, can perform the process of guiding the cleaning of the fixing unit based on the WAE estimated values.

The functions described in the respective embodiments are not limited to be configured using hardware, and can also be implemented using software by causing a computer to read programs storing the respective functions. The respective functions may be configured by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fixing device comprising:
a fixer including a fixed body and a heat source, the fixed body being configured to rotate and being in contact with a medium, the medium being configured to receive a developer image, and the heat source is configured to supply heat to the fixed body;
a temperature sensor configured to measure a temperature of a surface of the fixed body that is in contact with the medium, in which the temperature changes depending on the heat supplied from the heat source; and
a controller configured to clean the fixer when an estimated value of the temperature of the fixed body detected by the temperature sensor is higher than a predetermined value.

2. The device according to claim 1, wherein the temperature sensor includes a contact portion that is in contact with the surface of the fixed body that is in contact with the medium.

3. The device according to claim 1, wherein the controller further acquires an estimated value of the temperature of the fixed body based on a thermal capacity of the fixer and a thermal resistance of the fixer.

4. The device according to claim 1, wherein the controller further acquires an estimated value of the temperature of the fixed body based on a power supply voltage value of the fixer and an energization pulse that controls energization to the heat source.

5. The device according to claim 1, wherein the controller controls a display device to display a guide for cleaning the fixer.

6. The device according to claim 1, wherein the controller is configured to:
receive an instruction to clean the fixer from an operation device; and
in response to receiving the instruction, clean the fixer.

7. The device according to claim 1, wherein the temperature sensor includes a first temperature sensor configured to measure a temperature of a first region of the fixed body, and a second temperature sensor configured to measure a temperature of a second region of the fixed body; and
wherein the controller is configured to determine if the fixer needs to be cleaned based on a difference between a first estimated value, the first estimated value being a result of estimating the temperature of the first region of the fixed body, and a second estimated value, the second estimated value being a result of estimating the temperature of the second region of the fixed body.

8. The device according to claim 7, wherein the controller estimates the first estimated value and the second estimated value in a print waiting state.

9. The device according to claim 8, wherein the controller controls the temperature of the fixed body to be a target value for cleaning, the target value for cleaning is based on the difference between the first estimated value and the second estimated value, and causes the medium to pass through a region above the surface of the fixed body while the fixed body is at the target value for cleaning.

10. The device according to claim 9, wherein the fixed body is at the target value for cleaning and the controller is configured to:
set a control target temperature of the second region, the control target temperature being higher than a control target temperature in the print waiting state when the first estimated value is higher than the second estimated value; and
set the control target temperature of the second region to be higher than the control target temperature in the print waiting state when the second estimated value is higher than the first estimated value.

11. The device according to claim 7, wherein the controller is configured to determine if the fixer needs to be cleaned based on when the first estimated value is greater than or equal to a first upper limit value, and the second estimated value is greater than or equal to a second upper limit value, the controller further determines that the fixer needs to be cleaned.

12. An image forming apparatus comprising:
an image forming device configured to:
form a developer image, and
transfer the developer image to a medium;
a fixer comprising a fixed body and a heat source, the fixed body is configured to rotate and is in contact with the medium, wherein the medium is configured to receive a developer image, and the heat source is configured to supply heat to the fixed body;
a temperature sensor configured to measure a temperature of a surface of the fixed body in contact with the medium;
a heat source control circuit configured to control power supply to the heat source based on an estimated value of the temperature of the fixed body from the temperature sensor; and
a controller configured to clean the fixer when the estimated value of the temperature of the fixed body is higher than a predetermined value.

13. The image forming apparatus according to claim 12, wherein the temperature sensor includes a contact portion that is in contact with the surface of the fixed body that is in contact with the medium.

14. The image forming apparatus according to claim 12, wherein the controller is configured to acquire an estimated value of the temperature of the fixed body based on a thermal capacity of the fixer and a thermal resistance of the fixer.

15. The image forming apparatus according to claim 12, wherein the controller is further configured to acquire an estimated value of the temperature of the fixed body based on a power supply voltage value of the fixer and an energization pulse that controls energization to the heat source.

16. The image forming apparatus according to claim 12, wherein the controller controls a display device to display a guide for cleaning the fixer.

17. The image forming apparatus according to claim 12, wherein the controller is configured to:
receive an instruction to clean the fixer from an operation device; and
in response to receiving the instruction, clean the fixer.

18. The image forming apparatus according to claim 12, wherein the temperature sensor includes a first temperature sensor configured to measure a temperature of a first region of the fixed body, and a second temperature sensor configured to measure a temperature of a second region of the fixed body; and
wherein the controller is configured to determine whether to clean the fixer based on a difference between a first estimated value, the first estimated value being a result of estimating the temperature of the first region in the fixed body, and a second estimated value, the second estimated value being a result of estimating the temperature of the second region in the fixed body.

19. A method for a fixing device comprising:
detecting, by a first temperature sensor, a first temperature of a fixer;
detecting, by a second temperature sensor, a second temperature of the fixer;
acquiring, by the controller, the first temperature and the second temperature, determining, by the controller, whether the first temperature is less than or equal to a predetermined value;
determining, by the controller, whether the second temperature is less than or equal to the predetermined value;
in response to determining, by the controller, that both the first temperature or the second temperature is less than or equal to the predetermined value, executing, by the controller, a warm up operation;
calculating, by the controller, a plurality of estimated values of the temperature of the fixed body over a time period;
calculating, by the controller, an average temperature of the plurality of estimated values of the temperature;
determining, by the controller, whether the average temperature is greater than or equal to an upper limit; and
in response to the average temperature being greater than the upper limit, control by the controller, cleaning of the fixer.

20. The method of claim 19 further comprising:
setting a cleaning temperature;
rotating a fixed body, the fixed body configured to receive heat from a heat source; and
determining, by the controller, whether the temperature of the fixed body is greater than or equal to the cleaning temperature.
